(19) United States
(12) Patent Application Publication
(10) Pub. No.: US 2016/0267023 A1
(43) Pub. Date: Sep. 15, 2016

(54) DATA MANAGEMENT METHOD, INFORMATION PROCESSING SYSTEM, AND TERMINAL DEVICE

(71) Applicant: FUJITSU LIMITED, Kawasaki-shi (JP)

(72) Inventors: Prasad Dhananjaya PERUMPULI ARACHCHI, Yokohama (JP); Shingo KATO, Yokohama (JP); Takuro OYAMA, Yokohama (JP)

(73) Assignee: FUJITSU LIMITED, Kawasaki-shi (JP)

(21) Appl. No.: 15/055,139

(22) Filed: Feb. 26, 2016

(30) Foreign Application Priority Data
Mar. 13, 2015 (JP) 2015-050294

(51) Int. Cl. G06F 12/14; H04L 9/08

(52) U.S. Cl. CPC G06F 12/1408; H04L 9/0822; G06F 2212/1052

(57) ABSTRACT

A data management method includes receiving, by a terminal device, data stored in a first storage provided in an information processing device and storing the received data in a second storage provided in the terminal device, transmitting, to the information processing device, differential data between the data stored in the second storage and first updated data obtained by updating the data stored in the second storage, creating first encrypted data by encrypting the first updated data, deleting part of the created first encrypted data from the second storage, creating, by the information processing device, second encrypted data by encrypting second updated data obtained by updating the differential data transmitted from the terminal device, transmitting, to the terminal device, part of the second encrypted data which is identical in contents to the part of the first encrypted data deleted by the terminal device.

### CROSS-REFERENCE TO RELATED APPLICATION

This application is based upon and claims the benefit of priority of the prior Japanese Patent Application No. 2015-050294, filed on Mar. 13, 2015, the entire contents of which are incorporated herein by reference.

### FIELD

The present invention relates to a data management method, an information processing system, and a terminal device.

### BACKGROUND

Business persons who undertake a business trip to overseas sometimes need to carry highly confidential materials to overseas. In such a case, for example, a business person stores data (also referred to hereinbelow as “original data” or “working data”) for browsing the materials on a portable terminal device (also referred to hereinbelow simply as “terminal device”) such as a tablet terminal. Alternatively, for example, data for browsing the materials are stored in a domestic file server (the file server disposed in a country in which the business person resides), and the domestic file server is accessed from the business trip destination (overseas) through the terminal device. As a result, the business person can display and browse the materials on the terminal device at the business trip destination (see, for example, Japanese Laid-open Patent Publication No. 2004-021549, Japanese National Publication of International Patent Application No. 2007-520806, and Japanese Laid-open Patent Publication No. H07-302242).

### SUMMARY

According to an aspect of the embodiments, a data management method includes receiving, by a terminal device, data stored in a first storage provided in an information processing device and storing, by the terminal device, the received data in a second storage provided in the terminal device, transmitting, by the terminal device, to the information processing device, differential data between the data stored in the second storage and first updated data obtained by updating the data stored in the second storage, creating, by the terminal device, first encrypted data by encrypting the first updated data, deleting, by the terminal device, part of the created first encrypted data from the second storage, creating, by the information processing device, second encrypted data by encrypting second updated data obtained by updating the differential data transmitted from the terminal device, transmitting, by the information processing device, to the terminal device, part of the second encrypted data which is identical in contents to the part of the first encrypted data deleted by the terminal device, among the created second encrypted data, in response to a request from the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the entire configuration of an information processing system.

FIG. 2 illustrates the flow of data when the business person undertakes a business trip abroad.

FIG. 3 illustrates the flow of data when the business person undertakes a business trip abroad.

FIG. 4 illustrates the flow of data when the business person undertakes a business trip abroad.

FIG. 5 illustrates the flow of data when the business person undertakes a business trip abroad.

FIG. 6 illustrates the flow of data when the business person undertakes a business trip abroad.

FIG. 7 illustrates the flow of data when the business person undertakes a business trip abroad.

FIG. 8 illustrates the hardware configuration of the information processing device and overseas-based server.

FIG. 9 illustrates the hardware configuration of the terminal device.

FIG. 10 is a functional block diagram of the information processing device depicted in FIG. 8.

FIG. 11 is a functional block diagram of the terminal device depicted in FIG. 9.

FIG. 12 is a functional block diagram of the overseas-based server depicted in FIG. 8.

FIG. 13 is a flowchart illustrating the summary of the data management processing in the first embodiment.

FIG. 14 is a flowchart illustrating the summary of the data management processing in the first embodiment.

FIG. 15 is a flowchart illustrating the summary of the data management processing in the first embodiment.

FIG. 16 illustrates the data management device in the first embodiment.

FIG. 17 illustrates the data management device in the first embodiment.

FIG. 18 illustrates the data management device in the first embodiment.

FIG. 19 illustrates the data management device in the first embodiment.

FIG. 20 is a flowchart illustrating the detail of the data management processing in the first embodiment.

FIG. 21 is a flowchart illustrating the detail of the data management processing in the first embodiment.

FIG. 22 is a flowchart illustrating the detail of the data management processing in the first embodiment.

FIG. 23 is a flowchart illustrating the detail of the data management processing in the first embodiment.

FIG. 24 is a flowchart illustrating the detail of the data management processing in the first embodiment.

FIG. 25 is a flowchart illustrating the detail of the data management processing in the first embodiment.

FIG. 26 is a flowchart illustrating the detail of the data management processing in the first embodiment.

FIG. 27 is a flowchart illustrating the detail of the data management processing in the first embodiment.

FIG. 28 is a flowchart illustrating the detail of the data management processing in the first embodiment.

FIG. 29 is a flowchart illustrating the detail of the data management processing in the first embodiment.

FIG. 30 illustrates in detail the data management processing in the first embodiment.

### DESCRIPTION OF EMBODIMENTS

When the materials are to be browsed on the terminal device, all of the data for browsing the materials are stored in the terminal device. Therefore, when the business person loses the terminal device, this may lead to information leakage. Accordingly, in order to prevent the information leakage, the business person, for example, deletes the data stored in the terminal device each time the browsing of the materials on the terminal device is ended.

Meanwhile, when the business person updates the materials using the terminal device, the business person stores data after updating (also referred to hereinbelow as “updated data”) in another server (for example, the domestic file server) and then deletes the data stored in the terminal device. When the updated materials are browsed again on the terminal device, the business person acquires the updated data from the other server. In this way, even when the materials are updated using the terminal device, the business person can delete the data stored in the terminal device and can prevent the information leakage.

However, depending on the trip destination of the business person, the network infrastructure may sometimes be poor. In this case, the business person may have to spend a long time on storage of the updated data in the other server or acquisition of the updated data from the other server. The first embodiment will be explained hereinbelow.

[Configuration of Information Processing System]

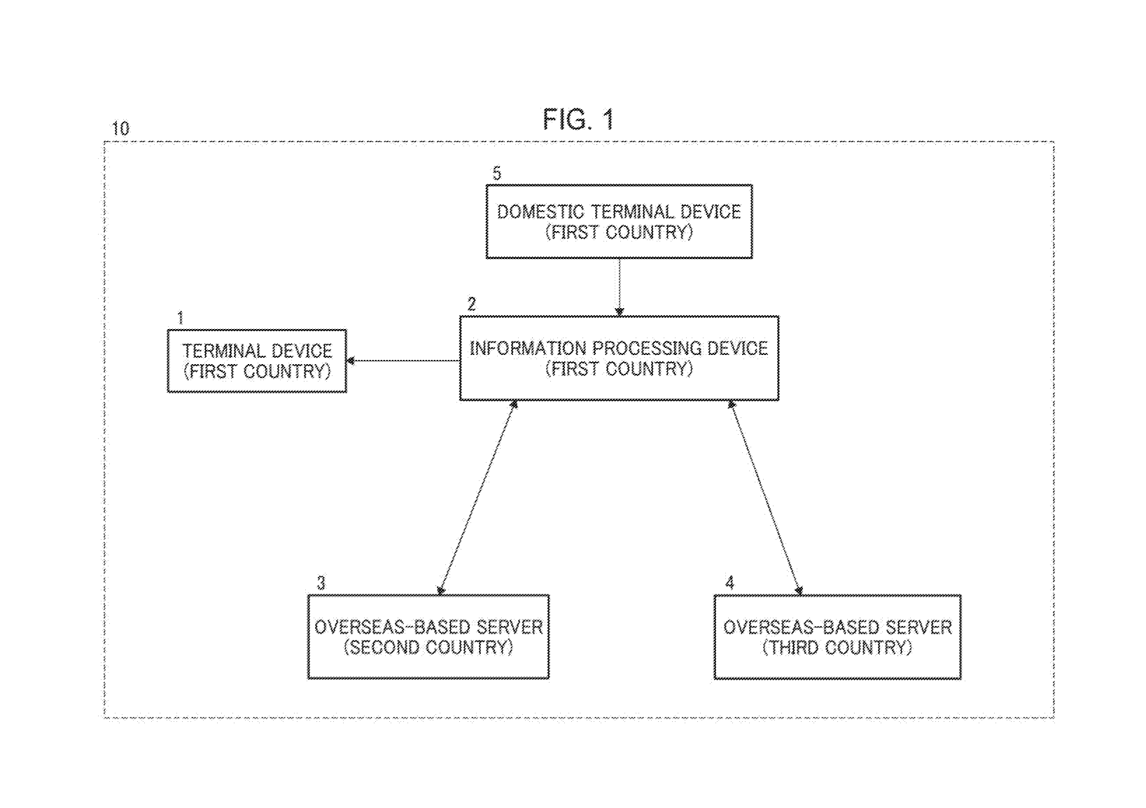

FIG. 1 illustrates the entire configuration of an information processing system. An information processing system 10 depicted in FIG. 1 has a terminal device 1, an information processing device 2 (also referred to hereinbelow as “master server 2”), and a domestic terminal device 5. The information processing system 10 depicted in FIG. 1 also has an overseas-based server 3 (also referred to hereinbelow as “storage device 3”), and an overseas-based server 4 (also referred to hereinbelow as “storage device 4”).

In the information processing system 10 depicted in FIG. 1, the terminal device 1, the information processing device 2, and the domestic terminal device 5 are disposed in the first country (for example, the country where a business person resides). Further, in the information processing system 10 depicted in FIG. 1, the overseas-based servers 3, 4 (also referred to hereinbelow as “storage devices 3, 4”) are disposed in the countries (referred to hereinbelow as “second country” and “third country”) different from the first country.

The information processing device 2 can be accessed from the terminal device 1 and the domestic terminal device 5 and enables the business person to store data via the terminal device 1 or the domestic terminal device 5.

The overseas-based servers 3, 4 each can access the information processing device 2 and enable the business person to store data via the information processing device 2.

The terminal device 1 is, for example, a portable terminal device such as a tablet terminal. When undertaking a business trip abroad, the business person, for example, stores the necessary materials in the terminal device 1 and takes the device with himself/herself.

The domestic terminal device 5 is a working terminal that is used by the business person conducting business in the first country.

[Specific Example in which the Business Person Undertakes a Business Trip from the First Country to the Second Country]

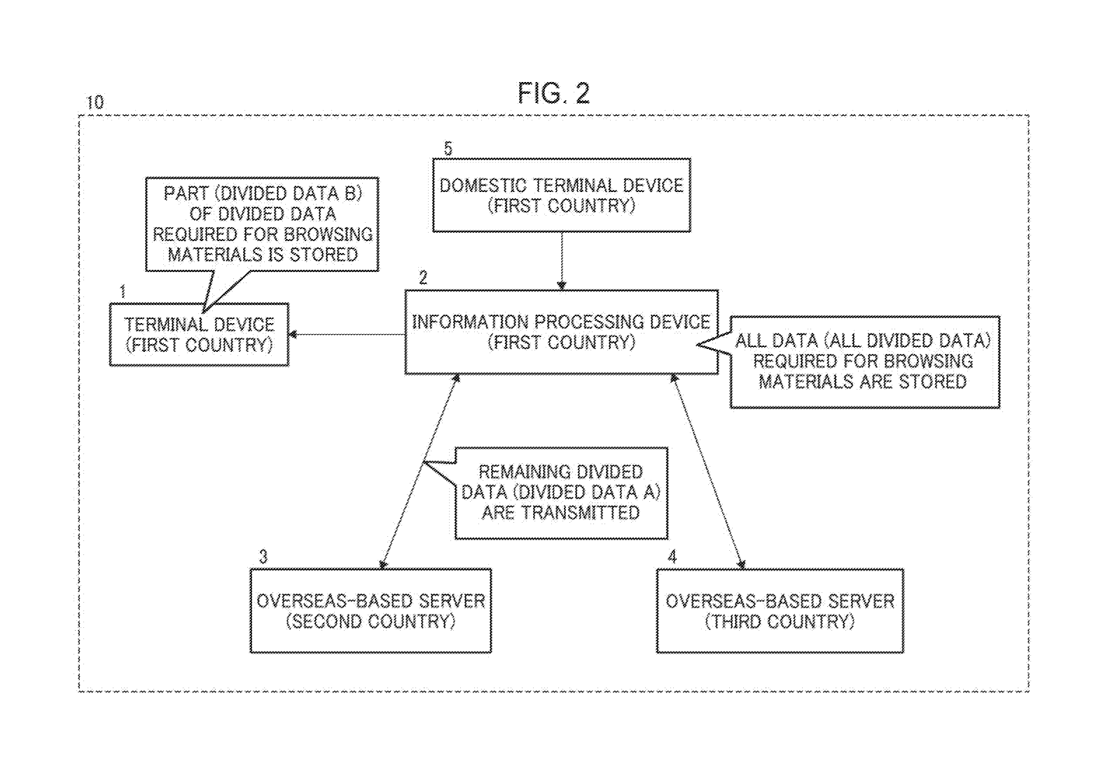

A specific example in which the business person undertakes a business trip from the first country to the second country will be described hereinbelow. FIGS. 2 to 6 illustrate the flow of data when the business person undertakes a business trip abroad.

As depicted in FIG. 2, the business person undertaking a business trip to the second country, for example, stores the data created in the domestic terminal device 5 (all of the data for browsing the materials to be carried out to the second country) in the information processing device 2.

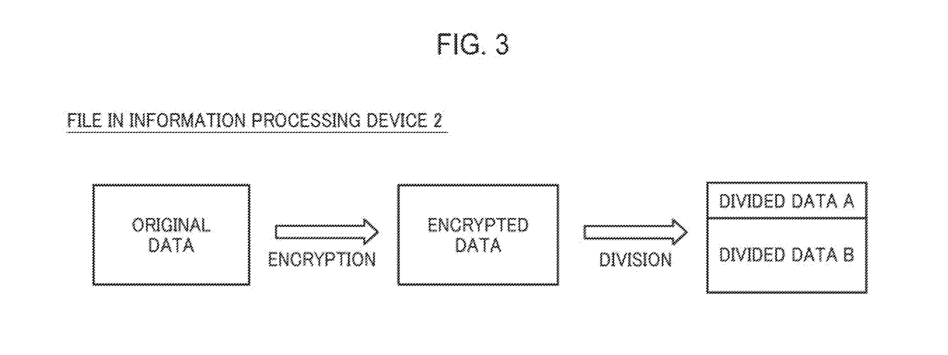

Then, the information processing device 2 stores some of the data stored by the business person (some of the data for browsing the materials to be carried out to the second country) in the terminal device 1. More specifically, as depicted in FIG. 3, the information processing device 2 encrypts the original data to create encrypted data and divides the encrypted data into divided data A and divided data B. As depicted in FIG. 2, the information processing device 2, for example, stores only the divided data B, among the created divided data, in the terminal device 1. Thus, the terminal device 1 cannot display the materials by using only the data stored in the terminal device 1.

Then, as depicted in FIG. 2, the information processing device 2 transmits the remaining divided data (divided data A) which have not been stored in the terminal device 1 to the overseas-based server 3 disposed in the second country into which the business person undertakes the business trip. As a result, the business person can rapidly acquire the remaining divided data when browsing the materials in the second country.

A specific example of the case in which the business person browses the materials after arriving to the second country will be explained hereinbelow.

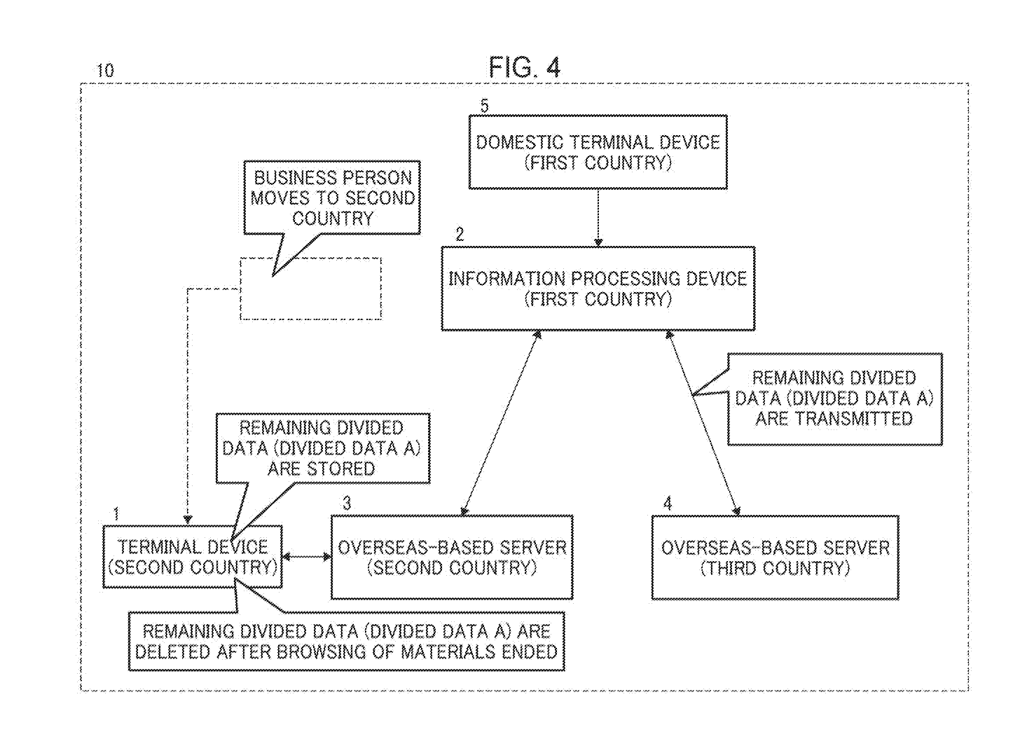

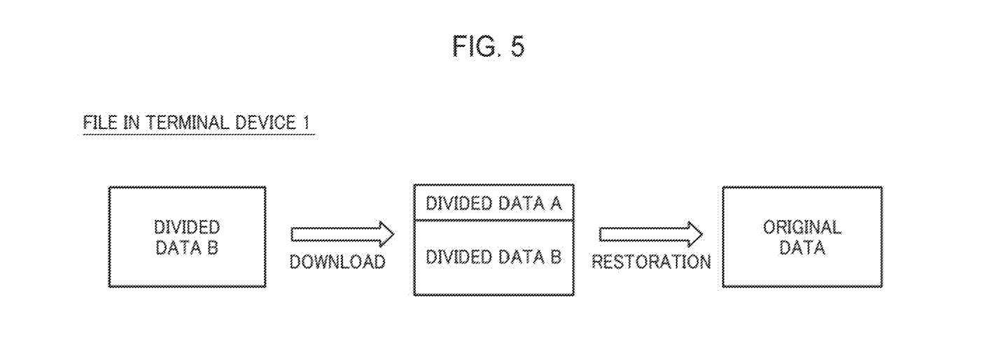

When the materials are to be browsed in the second country (when an input to the effect that the browsing of the materials is to be started is performed in the terminal device 1), the business person accesses the overseas-based server 3 and stores the remaining divided data (divided data A) in the terminal device 1, as depicted in FIG. 4. Then, the terminal device 1 combines together the divided data B that have been originally stored in the terminal device 1 and the divided data A acquired from the overseas-based server 3, thereby acquiring the restored original data, as depicted in FIG. 5. As a result, the terminal device 1 can display the materials.

When the browsing of the materials is ended, the business person deletes the remaining divided data (divided data A) acquired from the overseas-based server 3, as depicted in FIG. 4. More specifically, the terminal device 1 deletes the remaining divided data acquired from the overseas-based server 3 and the restored original data. As a result, even when the business person loses the terminal device 1 after browsing the materials in the second country, the occurrence of information leakage can be prevented.

Where it is determined that the business person who has undertaken the business trip to the second country travels to the third country, without returning to the first country, the information processing device 2 transmits the divided data A to the overseas-based server 4 disposed in the third country, for example, in the same manner as explained with reference to FIG. 2.

[Specific Example in which the Business Person Undertakes a Business Trip to the Third Country after the Second Country]

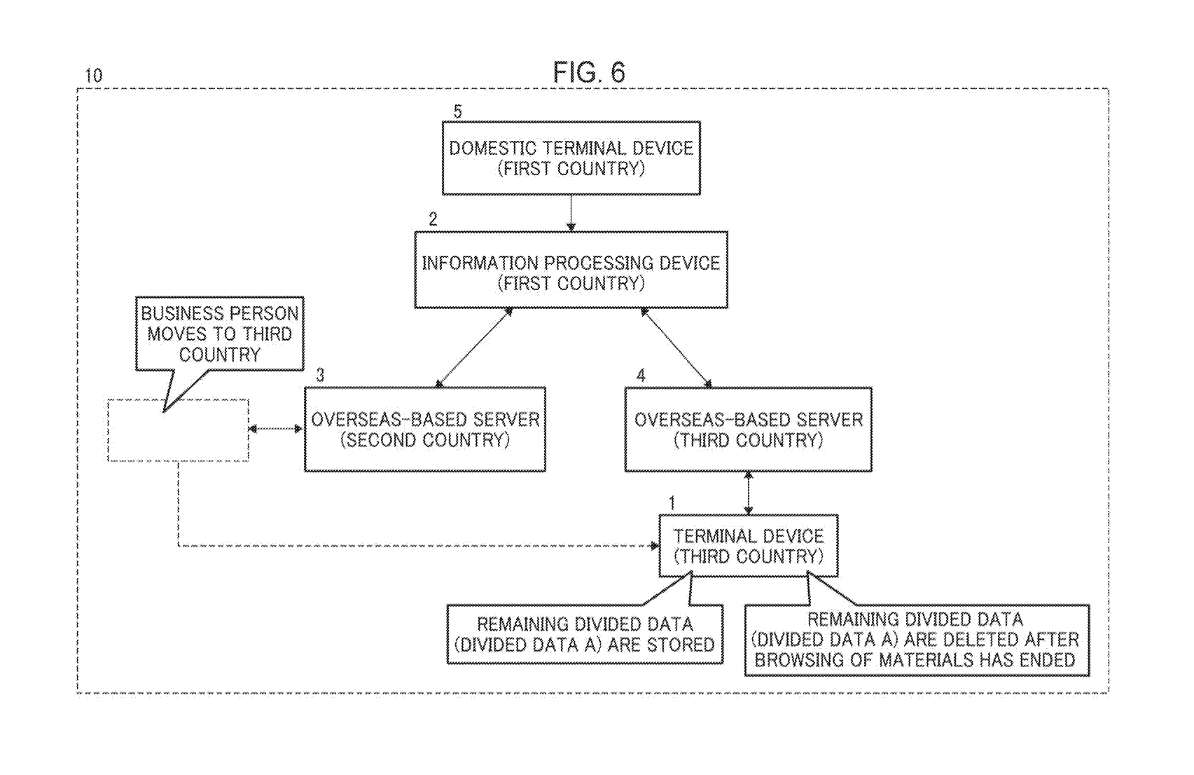

A specific example in which the business person undertakes a business trip to the third country after the second country will be explained hereinbelow. When the materials are to be browsed in the third country (when an input to the effect that the browsing of the materials is to be started is performed in the terminal device 1), the business person accesses the overseas-based server 4 and stores the remaining divided data (divided data A) in the terminal device 1, as depicted in FIG. 6. As a result, the terminal device 1 can store all of the data for the business person to browse the materials, in the same manner as in the case explained with reference to FIG. 4.

When the browsing of the materials is ended, the business person, for example, deletes the divided data A acquired from the overseas-based server 4. As a result, even when the business person loses the terminal device 1 after browsing the materials in the third country, the occurrence of information leakage can be prevented, in the same manner as in the case explained with reference to FIG. 4.

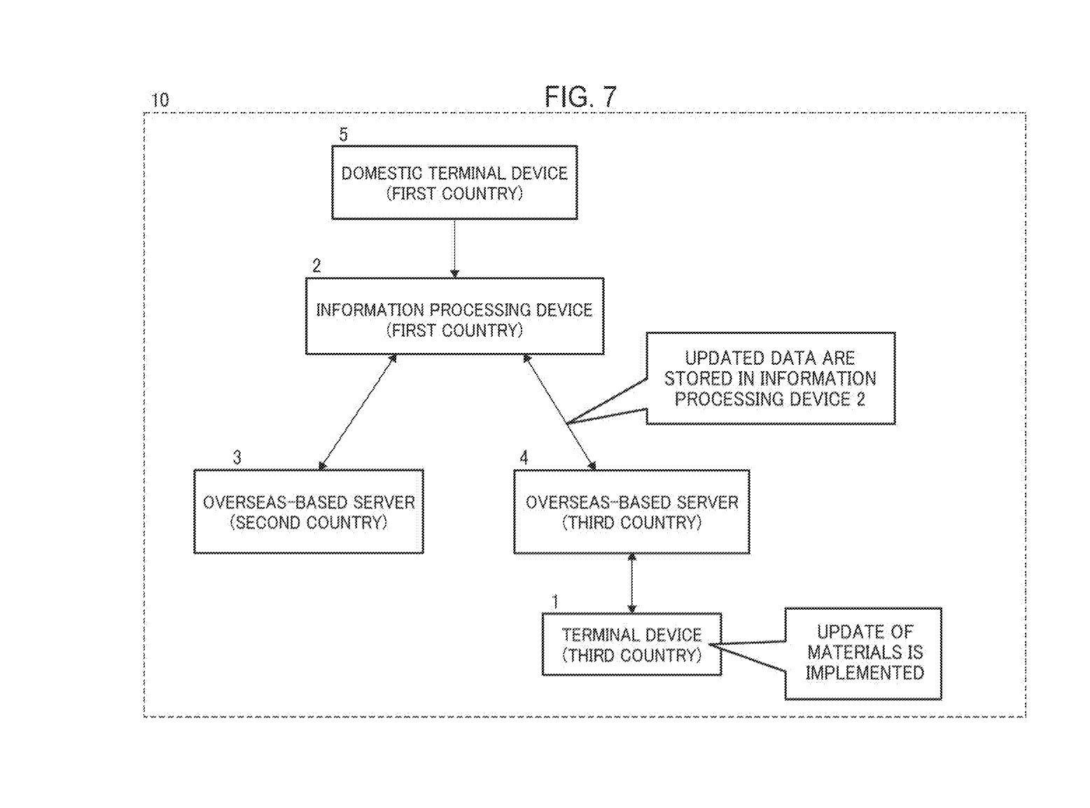

In this case, as depicted in FIG. 7, when the business person updates the materials in the third country, the business person needs to store the updated data in another server (for example, the information processing device 2) before deleting the data stored in the terminal device 1. When the updated materials are thereafter browsed, the business person acquires the updated data from the other server. As a result, even when the business person has updated the materials in the terminal device 1, the information leakage can be prevented.

However, for example, when the network infrastructure in the third country is poor, the business person spends a significant amount of time on storing the updated data in the other server.

Further, when the business person stores only part of the updated data in the other server and deletes part of the updated data stored in the other server from the terminal device 1, the business person can be unable to restore the updated data as a result of loss or damage of the terminal device 1.

Accordingly, in the present embodiment, when updating the original data, the terminal device 1 creates encrypted data (also referred to hereinbelow as “first encrypted data”) obtained by encrypting the updated data (also referred to hereinbelow as “first updated data”) obtained by updating the original data. Then, the terminal device 1 creates a plurality of divided data (also referred to hereinbelow as “first divided data”) obtained by dividing the created first encrypted data. The terminal device 1 then deletes some of the created plurality of the first divided data. The terminal device 1 also transmits differential data representing the difference between the original data before and after the update to the information processing device 2.

Meanwhile, the information processing device 2 which has received the differential data creates, on the basis of the differential data, updated data (also referred to hereinbelow as “second updated data”) identical in contents to the first updated data created by the terminal device 1. Then, the information processing device 2 creates encrypted data (also referred to hereinbelow as “second encrypted data”) obtained by encrypting the created second updated data and creates divided data (also referred to hereinbelow as “second divided data”) obtained by dividing the created encrypted data, in the same manner as in the processing in the terminal device 1. Thus, the information processing device 2 creates the second divided data identical in contents to the first divided data created in the terminal device 1.

When the first divided data deleted from the terminal device 1 are thereafter requested to be transmitted, the information processing device 2 transmits the second divided data identical in contents to the first divided data which are the object of the transmission request.

As a result, the information processing device 2 and the terminal device 1 can reduce the amount of data communication between the devices to prevent the occurrence of information leakage.

[Hardware Configuration of Information Processing System]

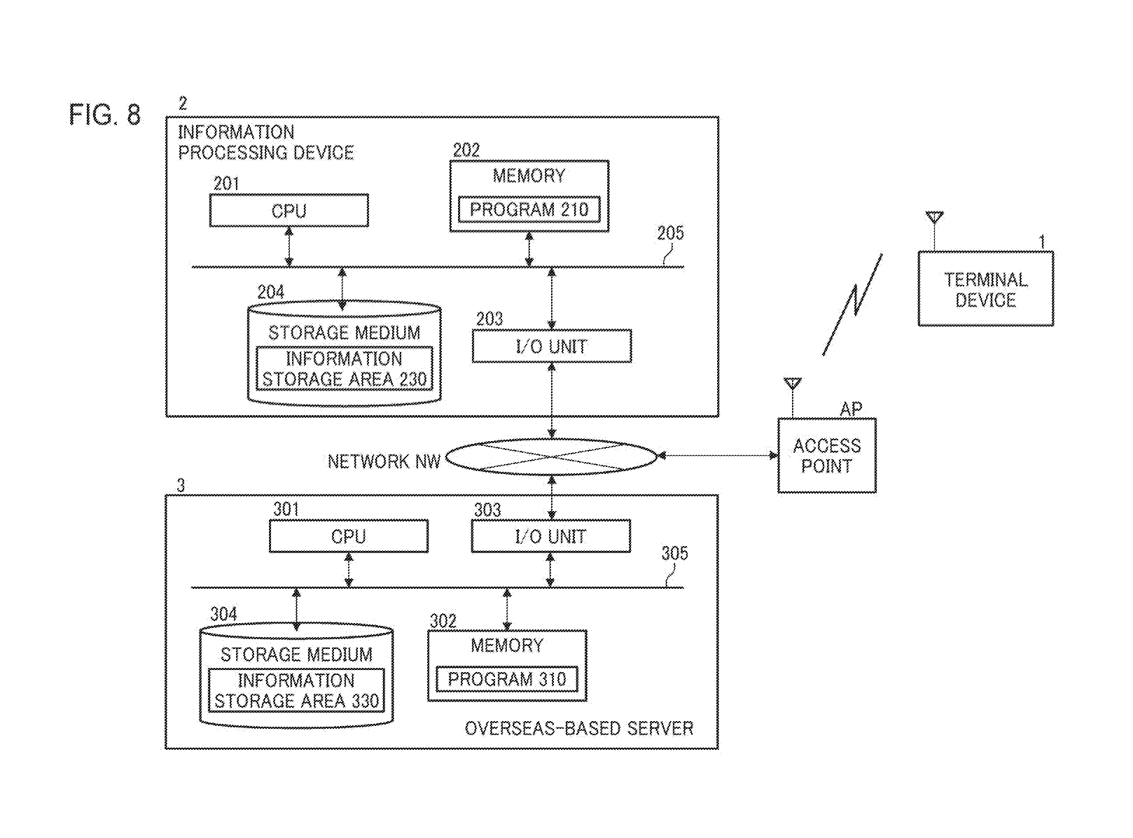

The configuration of the information processing system 10 will be described hereinbelow. FIG. 8 illustrates the hardware configuration of the information processing device and overseas-based server.

The information processing device 2 has a CPU 201 which is a processor, a memory 202, an external interface (I/O unit) 203, and a storage medium 204. The units are connected to each other by a bus 205.

The storage medium 204 stores a program 210 for executing the processing (also referred to hereinbelow as “data management processing”) for performing data management, for example, in a program storage area (not depicted in the figure) in the storage medium 204.

As depicted in FIG. 8, the CPU 201 loads the program 210 from the storage medium 204 into the memory 202 and performs the data management processing cooperatively with the program 210 when the program 210 is executed.

The storage medium 204 has, for example, an information storage area 230 (also referred to hereinbelow as “storage unit 230” or “first storage unit 230”) that stores information to be used when the data management processing is performed.

Further, the external interface 203, for example, performs communication with the terminal device 1 through a network NW and an access point AP. The external interface 203 also performs communication with the overseas-based servers 3, 4 through the network NW.

The hardware configuration of the overseas-based server 3 is described hereinbelow. The hardware configuration of the overseas-based server 4 is the same as the hardware configuration of the overseas-based server 3, and the explanation thereof is herein omitted.

The overseas-based server 3 has a CPU 301 which is a processor, a memory 302, an external interface (I/O unit) 303, and a storage medium 304. The units are connected to each other by a bus 305.

The storage medium 304 stores a program 310 for executing the data management processing, for example, in a program storage area (not depicted in the figure) in the storage medium 304.

As depicted in FIG. 8, the CPU 301 loads the program 310 from the storage medium 304 into the memory 302 and performs the data management processing cooperatively with the program 310 when the program 310 is executed.

The storage medium 304 has, for example, an information storage area 330 (also referred to hereinbelow as “storage unit 330”) that stores information to be used when the data management processing is performed.

Further, the external interface 303, for example, performs communication with the terminal device 1 through the network NW and access point AP. The external interface 303 also performs communication with the information processing device 2 through the network NW.

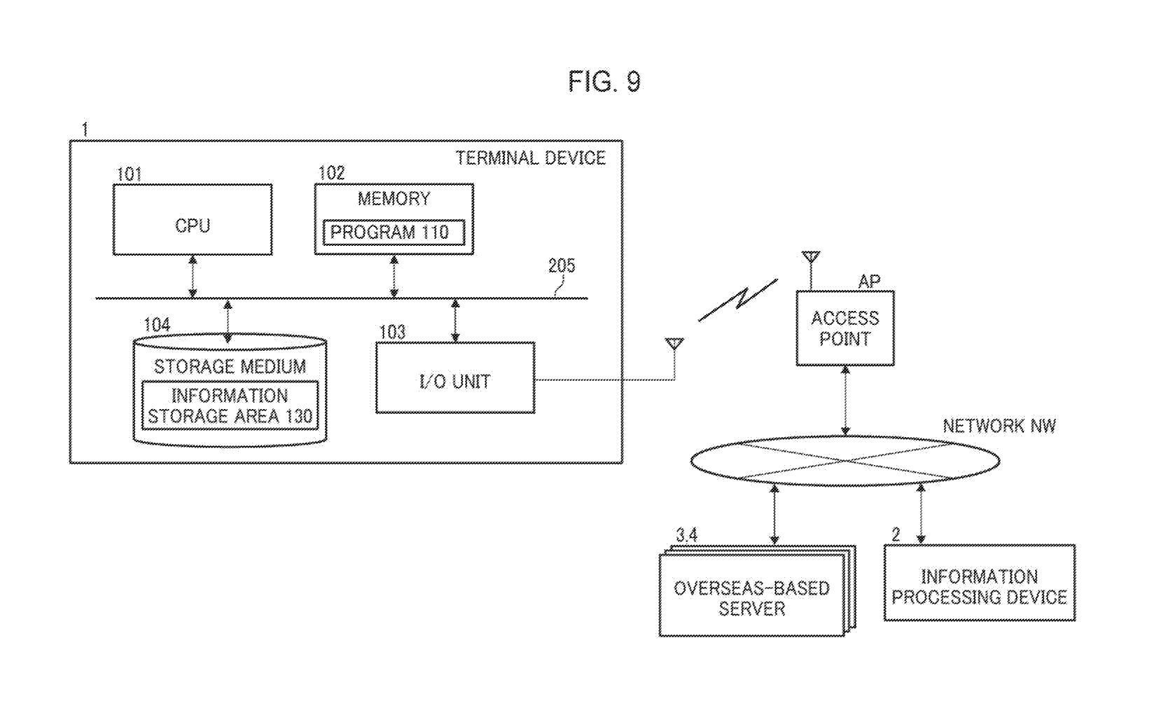

FIG. 9 illustrates the hardware configuration of the terminal device.

The terminal device 1 has a CPU 101 which is a processor, a memory 102, an external interface (I/O unit) 103, and a storage medium 104. The units are connected to each other by a bus 105.

The storage medium 104 stores a program 110 for executing the data management processing, for example, in a program storage area (not depicted in the figure) in the storage medium 104.

As depicted in FIG. 9, the CPU 101 loads the program 110 from the storage medium 104 into the memory 102 and performs the data management processing cooperatively with the program 110 when the program 110 is executed.

The storage medium 104 has, for example, an information storage area 130 (also referred to hereinbelow as “storage unit 130” or “second storage unit 130”) that stores information to be used when the data management processing is performed.

Further, the external interface 103, for example, performs communication with the information processing device 2 and the overseas-based servers 3, 4 through the network NW and access point AP.

[Software Configuration of Information Processing Device]

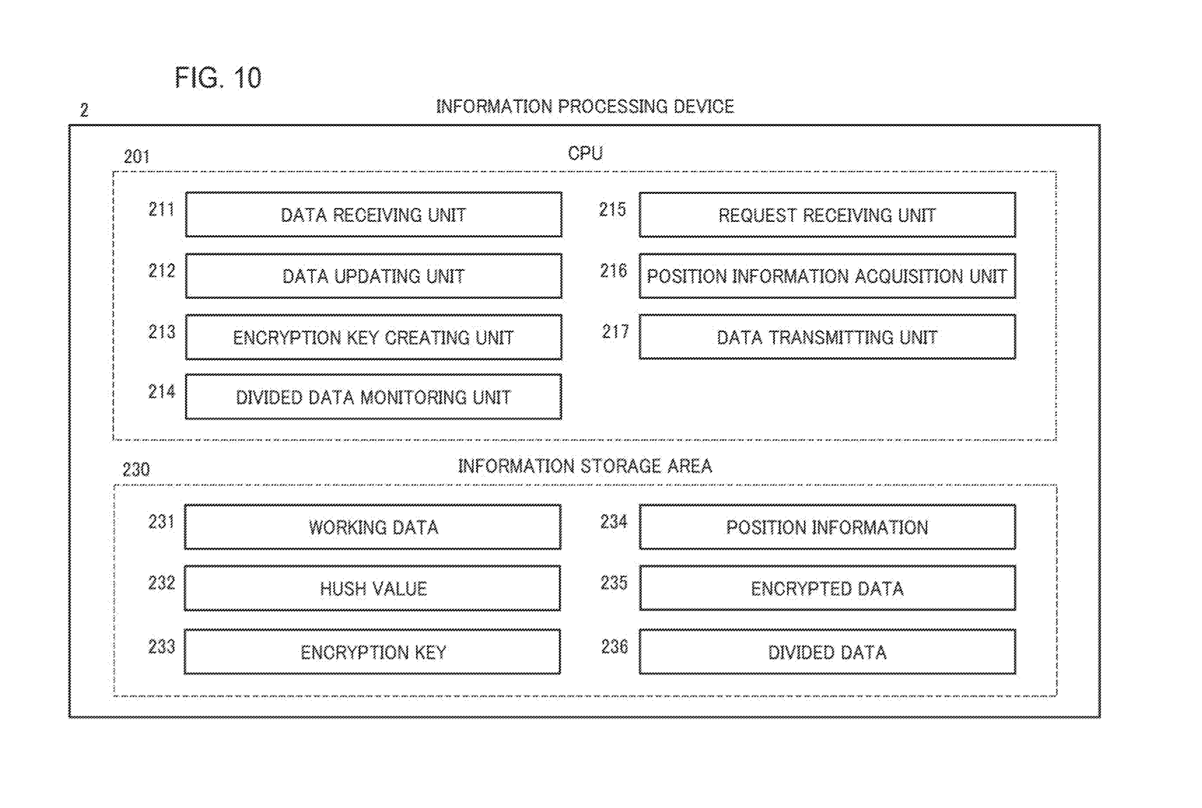

The software configuration of the information processing device 2 will be described hereinbelow. FIG. 10 is a functional block diagram of the information processing device depicted in FIG. 8. By cooperating with the program 210, the CPU 201 operates as a data receiving unit 211, a data updating unit 212, and an encryption key creating unit 213. By cooperating with the program 210, the CPU 201 also operates as a divided data management unit 214 (also referred to hereinbelow as “second encrypted data creating unit 214”, “second divided data creating unit 214”, or “data restoring unit 214”). Further, the CPU 201 also operates, cooperatively with the program 210, as a request receiving unit 215, a position information acquisition unit 216, and a data transmitting unit 217 (also referred to hereinbelow as “second transmitting unit 217”).

Working data 231, a hush value 232, an encryption key 233 (also referred to hereinbelow as “second encryption key 233”), and position information 234 are stored in the information storage area 230. Encrypted data 235 (also referred to hereinbelow as “second encrypted data 235”) and divided data 236 (also referred to hereinbelow as “second divided data 236”) are also stored in the information storage area 230.

The data receiving unit 211 stores the working data 231 transmitted from the domestic terminal device 5 depicted in FIG. 1. The working data 231 are, for example, data required for displaying on the terminal device 1 the materials that will be browsed by the business person.

The data receiving unit 211 also receives the differential data transmitted from the terminal device 1. The differential data represent the difference in data before and after updating when the below-described working data 131 have been updated in the terminal device 1.

The data updating unit 212 updates the working data 231 on the basis of the received differential data when the data receiving unit 211 receives the differential data from the terminal device 1 (the working data 231 after updating are also referred to hereinbelow as “updated data 231” or “second updated data 231”).

The encryption key creating unit 213, for example, calculates the hush value 232 from the received working data 231 when the data receiving unit 211 receives the working data 231 from the domestic terminal device 5. The encryption key creating unit 213 then creates the encryption key 233 on the basis of the calculated hush value 232. Then the encryption key creating unit 213 stores the created encryption key 233 in the information storage area 230.

Further, the encryption key creating unit 213, for example, calculates the hush value 232 from the received differential data when the data receiving unit 211 receives the differential data from the terminal device 1. The encryption key creating unit 213 then creates the encryption key 233 on the basis of the calculated hush value 232. Then the encryption key creating unit 213 stores the created encryption key 233 in the information storage area 230.

The encryption key creating unit 213 may create a new encryption key 233, for example, from the hush value 232 and the encryption key 233 of the previous generation.

The divided data management unit 214 creates the encrypted data 235 obtained by encrypting the working data 231, which have been received by the data receiving unit 211 from the domestic terminal device 5, with the encryption key 233 created by the encryption key creating unit 213. Then, the divided data management unit 214 creates the divided data 236 obtained by dividing the created encrypted data 235 into a plurality of data. Then, the divided data management unit 214 stores the created encrypted data 235 and divided data 236 in the information storage area 230.

The divided data management unit 214 also creates the encrypted data 235 obtained by encrypting the updated data 231, which have been created by the data updating unit 212, with the encryption key 233 created by the encryption key creating unit 213. Then, the divided data management unit 214 creates the divided data 236 obtained by dividing the created encrypted data 235 into a plurality of data. Then, the divided data management unit 214 stores the created encrypted data 235 and divided data 236 in the information storage area 230.

Thus, when the reception of the working data 231 or differential data is performed, the divided data management unit 214 performs the encryption and division of the working data 231 or updated data 231 with the encryption key 233 (the encryption and division are together referred to hereinbelow as “encryption processing”). A specific example of the encryption processing will be explained hereinbelow.

The request receiving unit 215 receives a transmission request for the divided data 236 stored in the information storage area 230 from the terminal device 1.

The position information acquisition unit 216 acquires the position information 234 on the terminal device 1 which is stored in the information storage area 130. The position information 234 is, for example, GPS (Global Positioning System) information.

The data transmitting unit 217 transmits the divided data 236 created by the divided data management unit 214 and the hush value 232 calculated by the encryption key creating unit 113 to the terminal device 1.

The data transmitting unit 217 also transmits the divided data 236 created by the divided data management unit 214 and the encryption key 233 created by the encryption key creating unit 213 to the overseas-based server 3 or the overseas-based server 4. In this case, the data transmitting unit 217, for example, specifies the overseas-based server disposed at a position which is the closest to the position indicated by the position information 234 from the position information 234 on the terminal device 1 received from the position information acquisition unit 216, and transmits the divided data 236, or the like, to the specified overseas-based server. Then, the data transmitting unit 217 transmits a transmission instruction to the overseas-based server disposes at a position which is the closest to the position of the terminal device 1 indicated by the position information 234, thereby transmitting the divided data 236, or the like, to the terminal device 1.

[Software Configuration of Terminal Device]

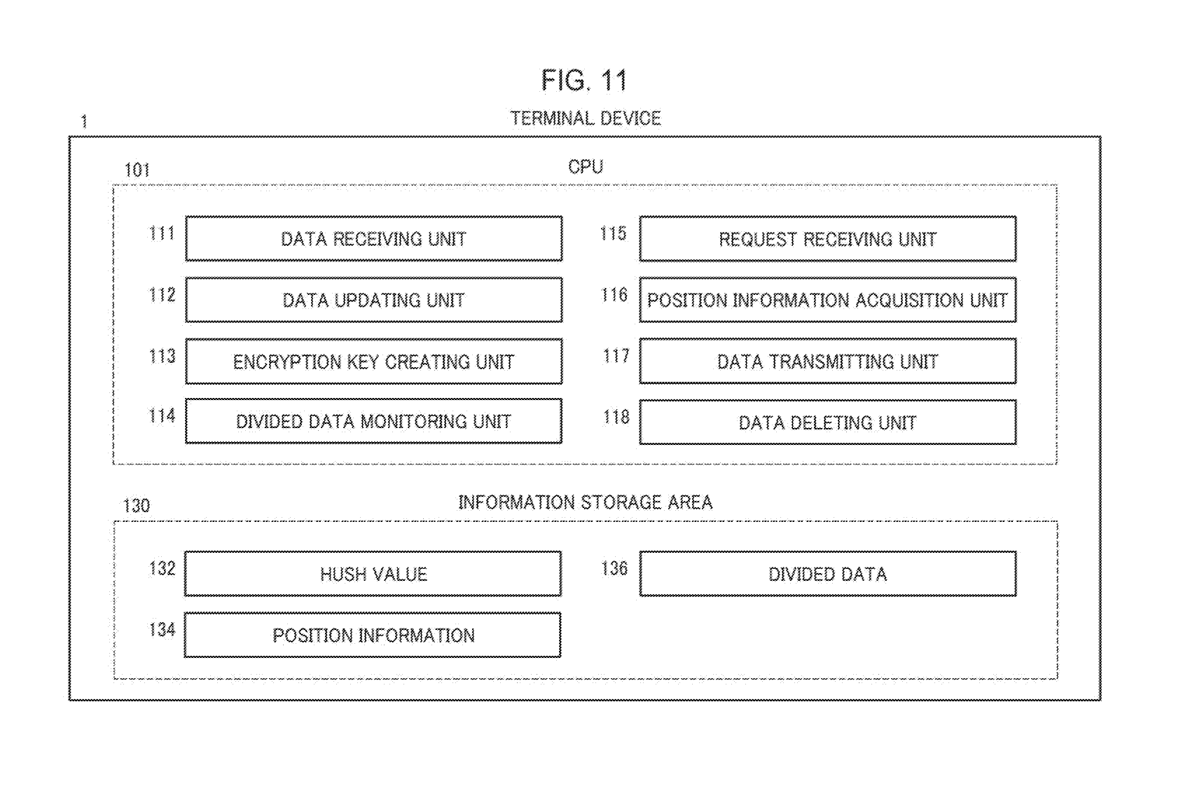

The software configuration of the terminal device 1 will be explained hereinbelow. FIG. 11 is a functional block diagram of the terminal device depicted in FIG. 9. The CPU 101 operates, cooperatively with the program 110, as a data receiving unit 111 (also referred to hereinbelow simply as “receiving unit 111”), a data updating unit 112, and an encryption key creating unit 113. The CPU 101 also operates, cooperatively with the program 110, as a divided data management unit 114 (also referred to hereinbelow as “first encrypted data creating unit 114” or “first divided data creating unit 114”) and a request transmitting unit 115. Further, by cooperating with the program 110, the CPU 101 also operates as a position information acquisition unit 116, a data transmitting unit 117 (also referred to hereinbelow as “first transmitting unit 117”), and a data deleting unit 118. When the data management processing is not performed, a hush value 132, position information 134, and divided data 136 (also referred to hereinbelow as “first divided data 136”) are stored in the information storage area 130.

The data receiving unit 111 receives the divided data 236 transmitted from the information processing device 2 and stores the received data, for example, as the divided data 136 in the information storage area 130. The data receiving unit 111 also receives the divided data (the below-descried divided data 336) transmitted from the overseas-based server 3, or the like, and stores the received data, for example, as the divided data 136 in the information storage area 130.

When the business person updates the working data 131 restored from the divided data 136, the data updating unit 112 creates the working data 131 after the update (also referred to hereinbelow as “updated data 131” or “first updated data 131”).

When the data updating unit 112 creates the updated data 131, the encryption key creating unit 113, for example, calculates the hush value 132 from the differential data between the working data 131 prior to updating and the updated data 131. Further, the encryption key creating unit 113 stores the calculated hush value 132 in the information storage area 130. Then, the encryption key creating unit 113 creates the encryption key 133 (also referred to hereinbelow “first encryption key 133”) on the basis of the calculated hush value 132.

The divided data management unit 114 creates the encrypted data 135 (also referred to hereinbelow as “first encrypted data 135”), which have been obtained by encrypting the updated data 131 created by the data updating unit 112, with the encryption key 133 created by the encryption key creating unit 113. The divided data management unit 114 then creates the divided data 136 obtained by dividing the created encrypted data 135 into a plurality of data.

The request transmitting unit 115 requests the transmission of the divided data 236 and the encryption key 233 to the information processing device 2, for example, when the business person performs an input to the effect that the working data 231 are to be browsed or updated (updated data 231 are to be created).

The position information acquisition unit 116, for example, acquires electromagnetic waves transmitted by a GPS satellite at periodic timings (at 30-min intervals) and calculates the position information 134. The position information acquisition unit 116, for example, stores the calculated position information 134 in the information storage area 130.

The data transmitting unit 117 transmits the differential data between the working data 131 prior to updating and the updated data 131 to the information processing device 2. The differential data may be created, for example, by the divided data management unit 114.

The data deleting unit 118 deletes the created encryption key 133, the encrypted data 135, and some of the plurality of divided data 136 from the information storage area 130 after the divided data management unit 114 has created the divided data 136. The data deleting unit 118 also deletes the wording data 131, which have been restored for the business person to perform the browsing, or the like, from the terminal device 1. Thus, the data deleting unit 118 sets a state in which the working data 131 cannot be restored only from the information stored in the information storage area 130. As a result, the business person can prevent the occurrence of information leakage caused by the loss of the terminal device 1, or the like.

[Software Configuration of the Overseas-Based Server]

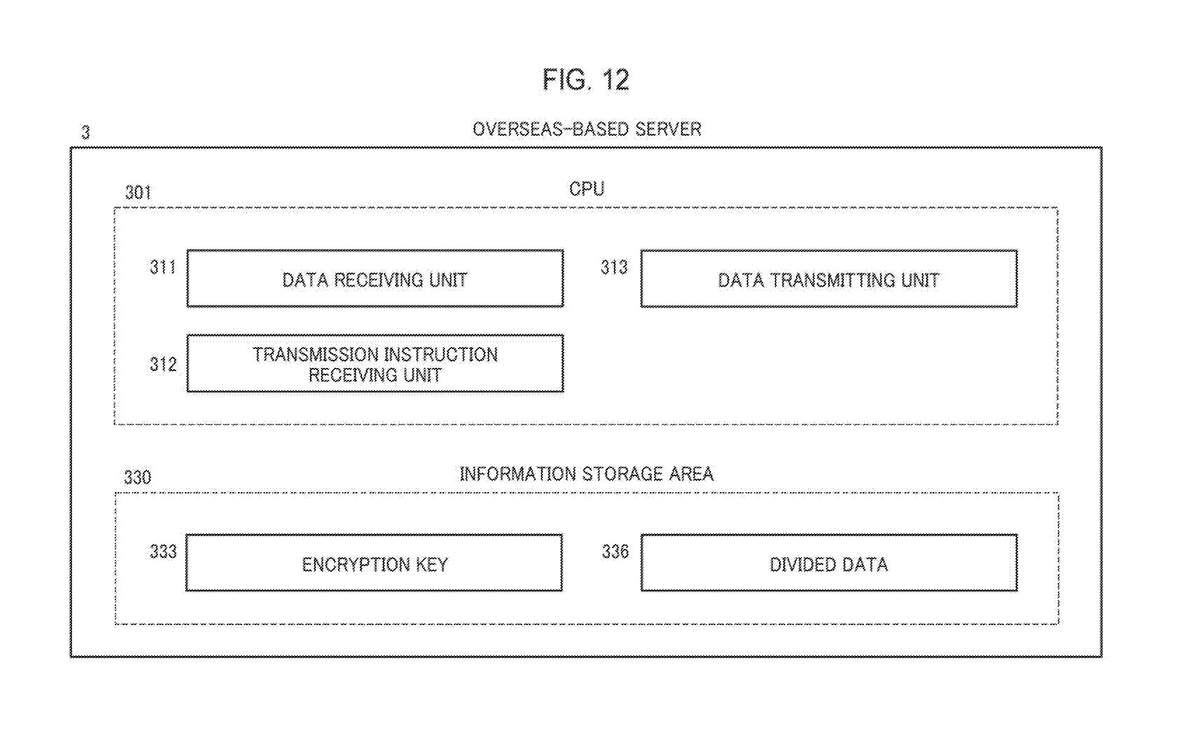

The software configuration of the overseas-based server 3 will be explained hereinbelow. FIG. 12 is a functional block diagram of the overseas-based server depicted in FIG. 8. The CPU 301 functions, cooperatively with the program 310, as a data receiving unit 311, a transmission instruction receiving unit 312, and a data transmitting unit 313. An encryption key 333 and divided data 336 are stored in the information storage area 330. The software configuration of the overseas-based server 4 is the same as the software configuration of the overseas-based server 3 and the explanation thereof is herein omitted.

The data receiving unit 311 receives the divided data 236 transmitted from the information processing device 2 and, for example, stores the received data as the divided data 336 in the information storage area 330.

The transmission instruction receiving unit 312 receives the transmission instruction (the instruction to transmit the divided data 336 and the encryption key 333) transmitted from the information processing device 2.

When the transmission instruction receiving unit 312 receives the transmission instruction, the data transmitting unit 313 transmits the divided data 336 and the encryption key 333 stored in the information storage area 330 to the terminal device 1.

### Summary of the First Embodiment

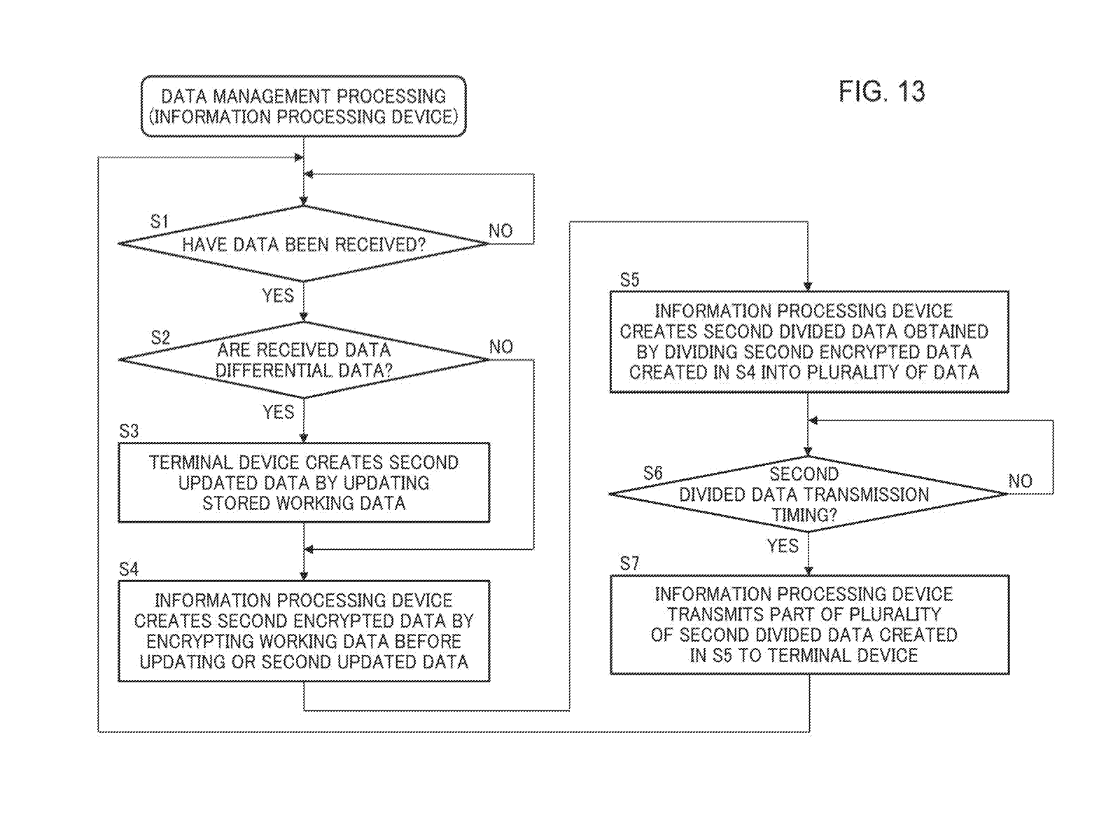

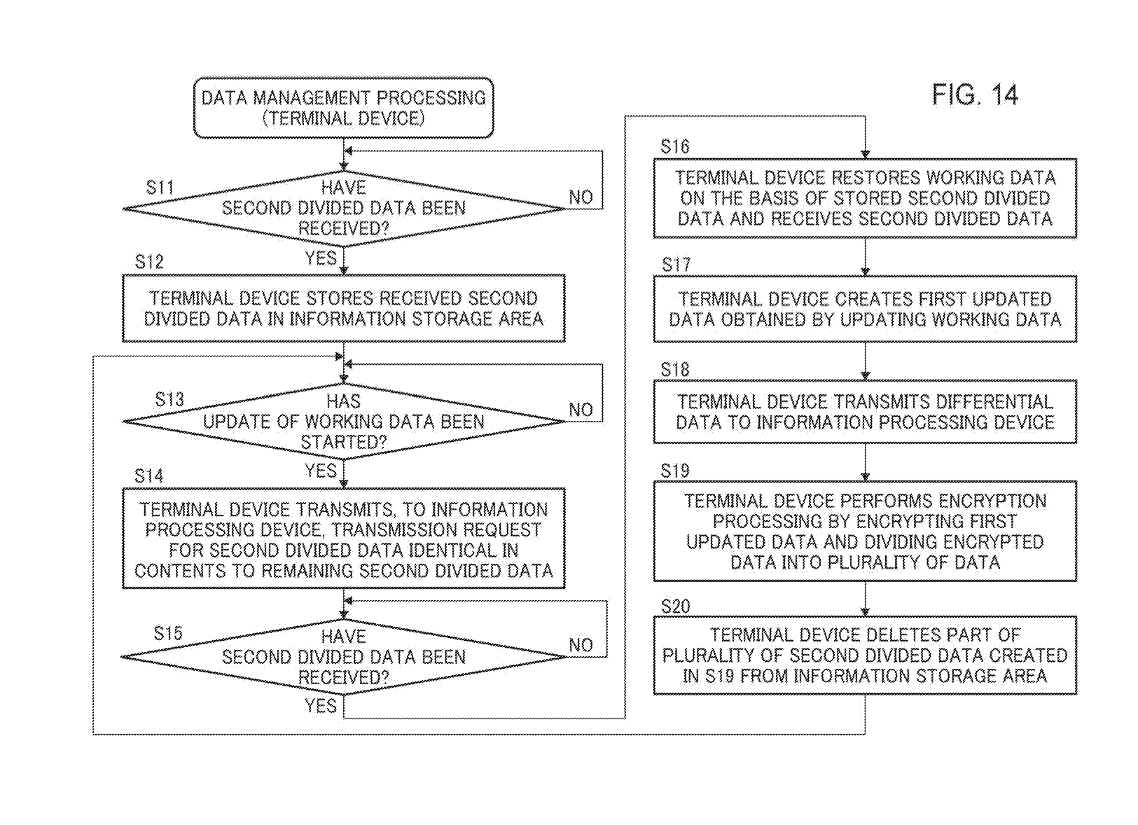

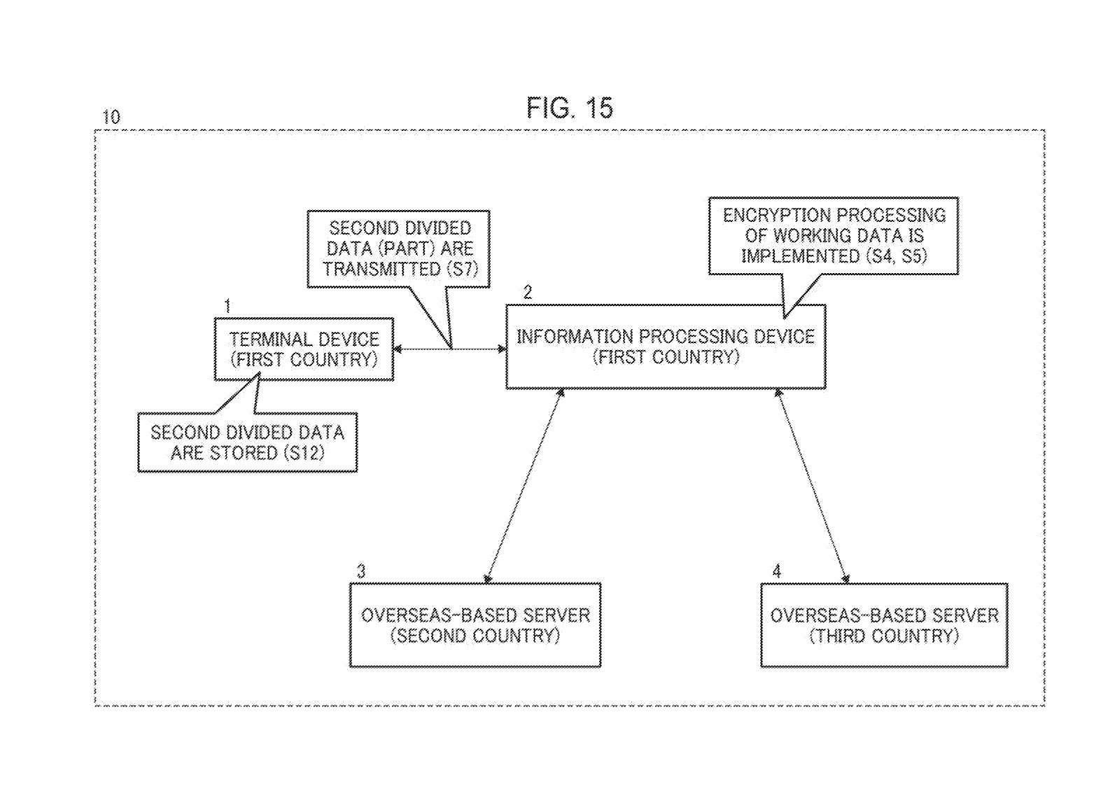

The first embodiment will be summarized hereinbelow. FIGS. 13 and 14 are flowcharts illustrating the summary of the data management processing in the first embodiment. FIGS. 15 to 19 illustrate the summary of the data management processing in the first embodiment. The data management processing illustrated by FIGS. 13 and 14 will be explained with reference to FIGS. 15 to 19.

[Processing (1) in the Information Processing Device]

The processing in the information processing device 2 will be describes with reference to FIG. 13. The information processing device 2 waits till data are received from the terminal device 1 or the overseas-based servers 3, 4 (NO in S1). More specifically, the information processing device 2 waits till the working data 231 transmitted from the terminal device 1 or the differential data transmitted from the overseas-based servers 3, 4 are received.

Then, for example, when the working data 231 are received (YES in S1, NO in S2), the information processing device 2 performs the encryption processing of the working data 231, as depicted in FIG. 15. Thus, the information processing device 2 creates the encrypted data 235 obtained by encrypting the working data 231 (S4) and creates the divided data 236 obtained by diving the encrypted data 235, which have been created in S4, into a plurality of data (S5).

Then, the information processing device 2 waits till the timing (also referred to hereinbelow as “divided data transmission timing”) at which the divided data 236 created in S4 are transmitted (NO in S6). The divided data transmission timing is, for example, the timing at which a request to transmit the divided data 236 has been received from the terminal device 1. The divided data transmission timing may be also the timing at which the information processing device 2 has created the divided data 236 in S5.

When the divided data transmission timing has been reached (YES in S6), the information processing device 2 transmits part of the divided data 236 created in S5 to the terminal device 1 as depicted in FIG. 15 (S7).

[Processing in Terminal Device] The processing in the terminal device 1 will be explained hereinbelow with reference to FIG. 14. The terminal device 1 waits till the divided data 236 are received from the information processing device 2 (NO in S11). Once the divided data 236 have been received from the information processing device 2 (YES in S11), as depicted in FIG. 15, the terminal device 1 stores the received divided data 236 as the divided data 136 in the information storage area 130 (S12).

In this case, in S12, the divided data 136 which have been stored by the terminal device 1 in the information storage area 130 are part of the plurality of divided data 236 created by the information processing device 2 (part of the data necessary for displaying the materials which are to be browsed by the business person during the business trip). Thus, the terminal device 1 cannot display the materials which are planned for browsing by the business person with only the divided data 136 stored in the information storage area 130 in S12. As a result, the business person can prevent the occurrence of information leakage even when the terminal device 1 is lost after the processing of S12.

Then, the terminal device 1 waits till the update of the working data 131 is started (NO in S13). Thus, the terminal device 1 waits till the business person moves to the second country and performs an input to the effect that the updating of the materials corresponding to the working data 131 is to be started.

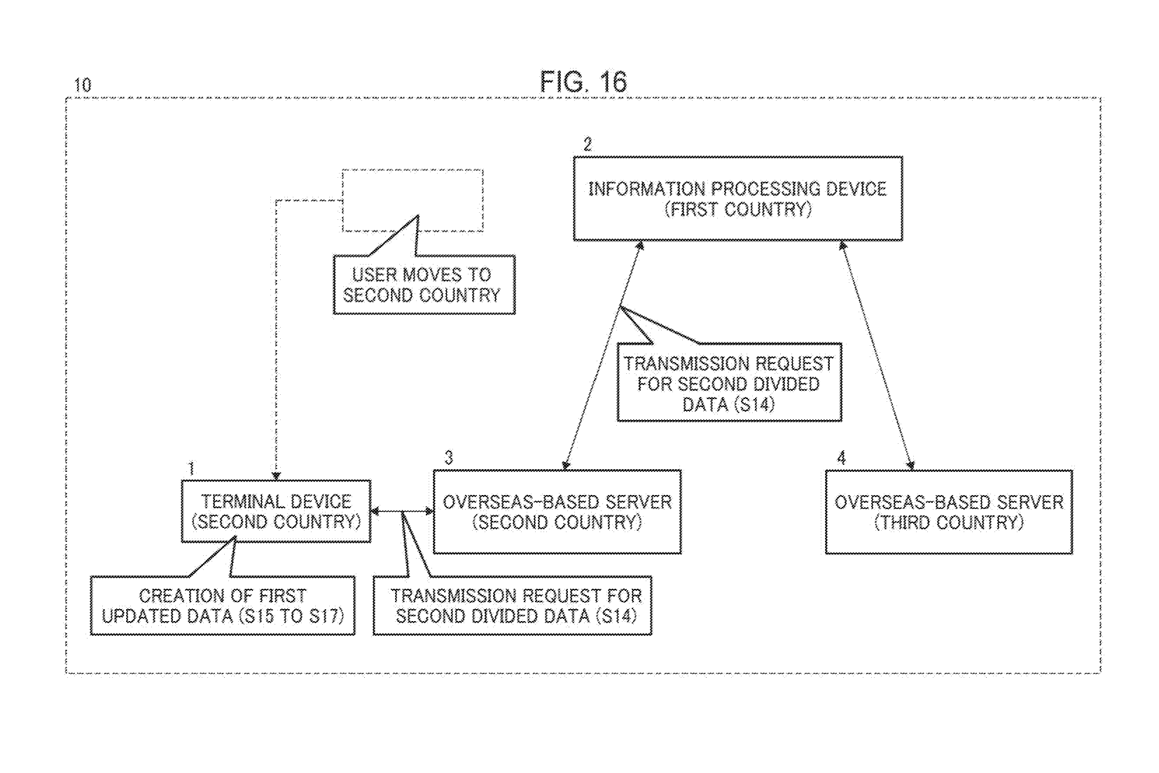

When the updating of the working data 131 is started (YES in S13), the terminal device 1 transmits the transmission request for the divided data 236 to the information processing device 2 as depicted in FIG. 16 (S14). More specifically, the terminal device 1 transmits to the information processing device 2 the transmission request for the divided data 236 identical in contents to the divided data 136 which have not been stored in the information storage area 130, among the divided data 136 necessary for restoring the working data 131 (S14). Then, the terminal device 1 waits till the divided data 236 corresponding to the transmission request are received from the information processing device 2 (NO in S15).

When the divided data 236 corresponding to the transmission request are received from the information processing device 2 (YES in S15), the terminal device 1 restores the working data 131 by the divided data 136 which have already been stored in the information storage area 130 and the divided data received in S15 (S16). As a result, the business person can update the materials corresponding to the working data 131 in the trip destination.

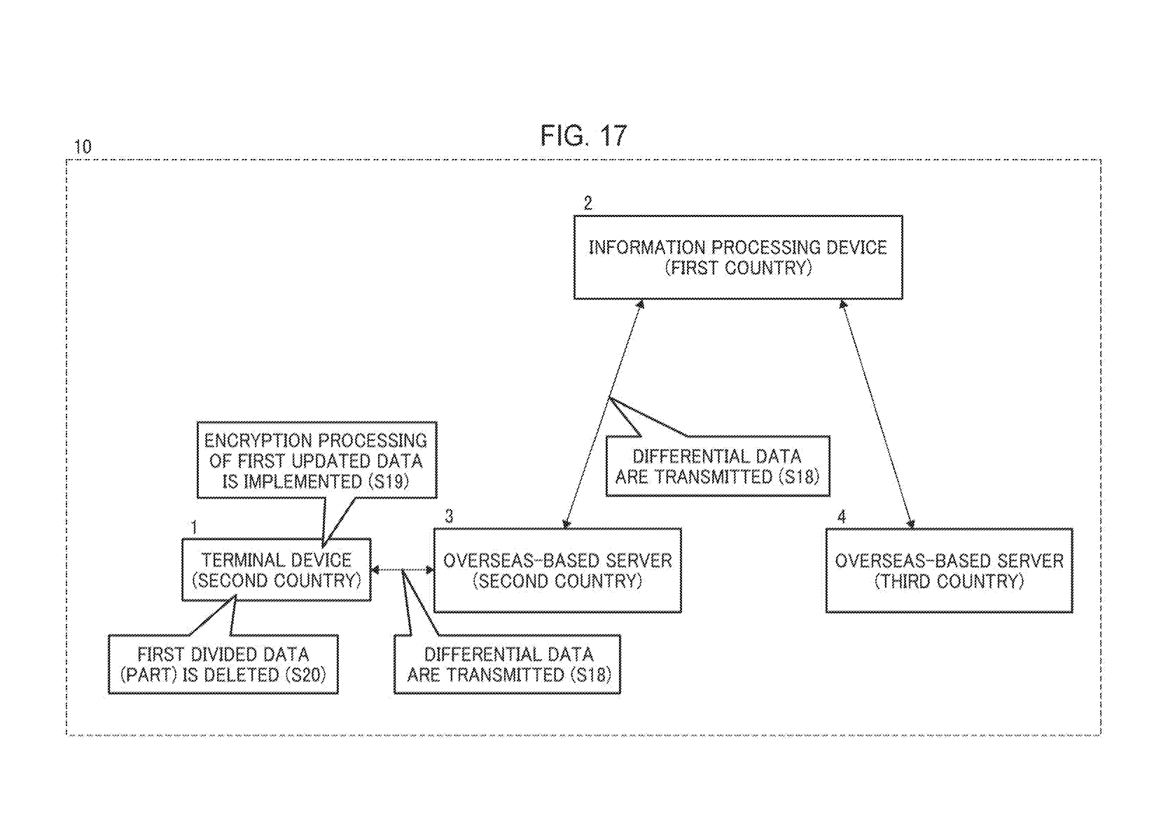

Then, as depicted in FIG. 16, the terminal device 1 updates the working data 131 (creates the updated data 131), which have been restored in S16, on the basis of the contents of the input made by the business person (S17). The terminal device 1 then extracts the differential data between the working data 131 before the update and the updated data 131 and, as depicted in FIG. 17, transmits the extracted differential data to the information processing device 2 (S18).

Thus, when creating the updated data 131, the terminal device 1 transmits only the extracted differential data to the information processing device 2, instead of transmitting all of the created updated data 131 to the information processing device 2. As a result, the terminal device 1 can shorten the time required for data transmission even when the network infrastructure in the business trip destination is poor. Further, as depicted in FIG. 17, the terminal device 1 transmits the differential data to the information processing device 2 through the overseas-based server 3 disposed in the second country.

Then, as depicted in FIG. 17, the terminal device 1 performs the encryption processing of encrypting the updated data 131 and dividing into a plurality of data, and creates a plurality of divided data 136 (S19). Then, as depicted in FIG. 17, the terminal device 1 deletes part of the divided data 136 from the information storage area 130 (S20).

Thus, by deleting part of the divided data 136 after creating the updated data 131, the terminal device 1 creates a state (state in which the working data 131 cannot be restored) in which the materials corresponding to the divided data 136 cannot be displayed by only the divided data 136 stored in the information storage area 130. As a result, the business person can prevent the occurrence of information leakage even when the terminal device 1 is lost after the creation of the updated data 131.

[Processing (2) in Information Processing Device]

The processing (processing performed after S18 in FIG. 14) in the information processing device 2 will be explained hereinbelow with reference to FIG. 13.

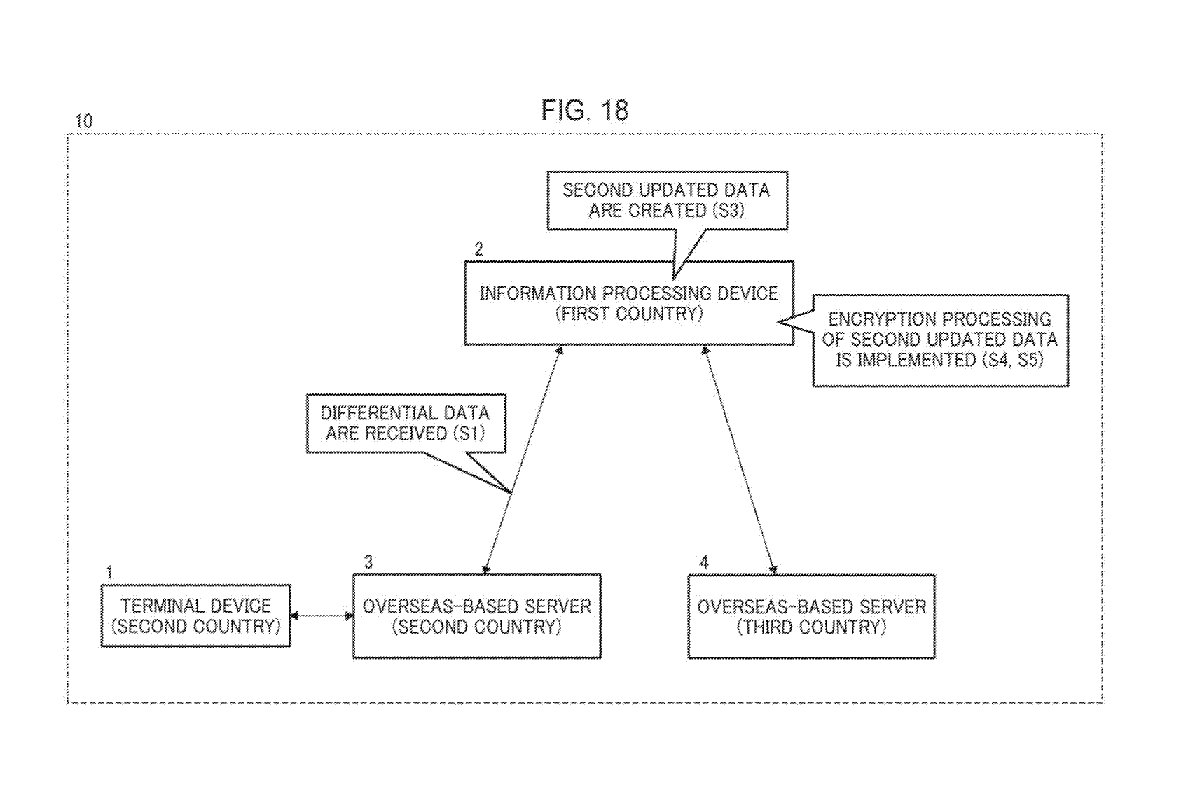

When the differential data are received from the terminal device 1 (YES in S1, YES in S2), the information processing device 2 creates, as depicted in FIG. 18, the updated data 231 on the basis of the differential data received from the terminal device 1 and the working data 231 stored in the information storage area 230 (S3).

Thus, the information processing device 2 creates the updated data 231 from the working data 231 identical in contents to the working data 131 stored in the information storage area 130 of the terminal device 1 and the differential data received from the terminal device 1. As a result, the information processing device 2 can create the updated data 231 identical in contents to the updated data 131 created in the terminal device 1. Further, the information processing device 2 can perform the same processing as the encryption processing, which has been executed in the terminal device 1, on the basis of the created updated data 231.

Then, as depicted in FIG. 18, the information processing device 2 performs the encryption processing with respect to the updated data 231 created in S3. More specifically, the information processing device 2 creates the encrypted data 235 by encrypting the updated data 231 (S4) and divides the created encrypted data 235 into plurality of data to create the divided data 236 (S5). Thus, the information processing device 2 performs the same processing as the terminal device 1 and creates the divided data 236 identical in contents to the divided data 136 created in the terminal device 1.

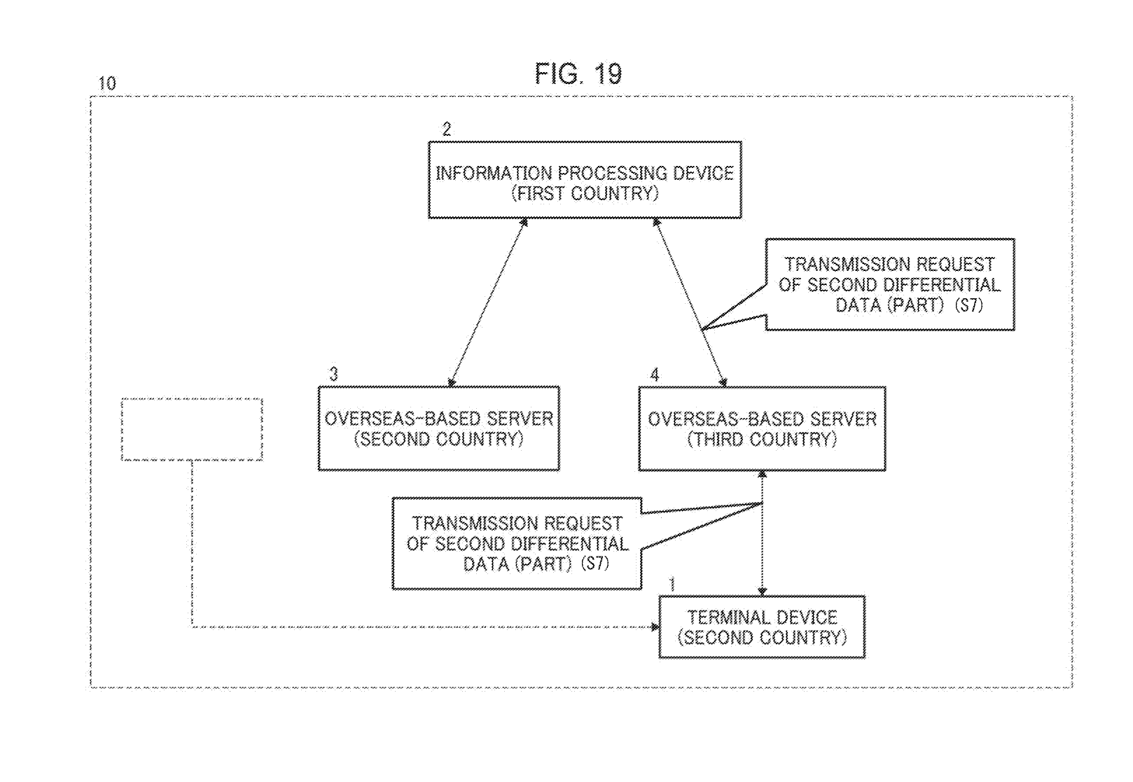

Then, the information processing device 2 waits till the transmission request for the divided data 236 is received from the terminal device 1 (NO in S6). Thus, as depicted in FIG. 19, the terminal device 1 waits till the business person moves from the second country to the third country and performs an input to the effect that updating of the materials corresponding to the working data 131 is to be started. Once the transmission request for the divided data 236 has been received (YES in S6), the information processing device 2, as depicted in FIG. 19, transmits the divided data 236 identical in contents to the divided data 136 deleted by the terminal device 1 (S7). In the example depicted in FIG. 19, the terminal device 1 transmits the transmission request for the divided data 236 to the information processing device 2 through the overseas-based server 4 disposed in the third country. Further, in the example depicted in FIG. 19, the information processing device 2 transmits the divided data to the terminal device 1 through the overseas-based server 4.

Thus, the information processing device 2 creates in advance the plurality of divided data 236 identical in contents to the respective data of the plurality of divided data 136 created in the terminal device 1 so as to enable the transmission of the divided data 236 to the terminal device 1. As a result, the terminal device 1 can receive from the information processing device 2 the divided data 236 identical in contents to the deleted divided data 136 even when part of the divided data 136 has been deleted to prevent the occurrence of information leakage. Therefore, after the business person has updated the materials, the terminal device 1 can maintain the state in which part of the divided data 136 has been deleted.

Further, in the information processing device 2, the updated data 231 (updated data 131) can be restored from the divided data 236 stored in the information storage area 230 even when the terminal device 1 is lost after the business person has created the updated data 231.

Thus, according to the first embodiment, the terminal device 1 receives the working data 231, which have been stored in the first storage unit 230 provided in the information processing device 2, in the second storage unit 130 provided in the terminal device 1. The terminal device 1 also transmits, to the information processing device 2, the differential data between the working data 131 stored in the second storage unit 130 and the updated data 131 which are obtained by updating the working data 131.

Further, the terminal device 1 creates the encrypted data 135 by encrypting the updated data 131, and creates the divided data 136 by dividing the created encrypted data 135 into a plurality of data. The terminal device 1 also deletes part of the created plurality of divided data 136 from the second storage unit 130.

Meanwhile, the information processing device 2 creates the encrypted data 235 by encrypting the updated data 231 subjected to updating on the basis of the differential data transmitted from the terminal device 1, and creates the divided data 236 by dividing the created encrypted data 235 into a plurality of data. The information processing device 2 then transmits the divided data 236 identical in contents to the divided data 136 deleted in the terminal device 1 to the terminal device 1 in response to a transmission request from the terminal device 1.

As a result, the terminal device 1 and the information processing device 2 can reduce the data communication amount for preventing the occurrence of information leakage. Further, by performing the division, with respect to the updated data 131, 231, the terminal device 1 and the information processing device 2 can prevent incorrect restoration of the encrypted data 135, 235 by a malicious person.

### Details of the First Embodiment

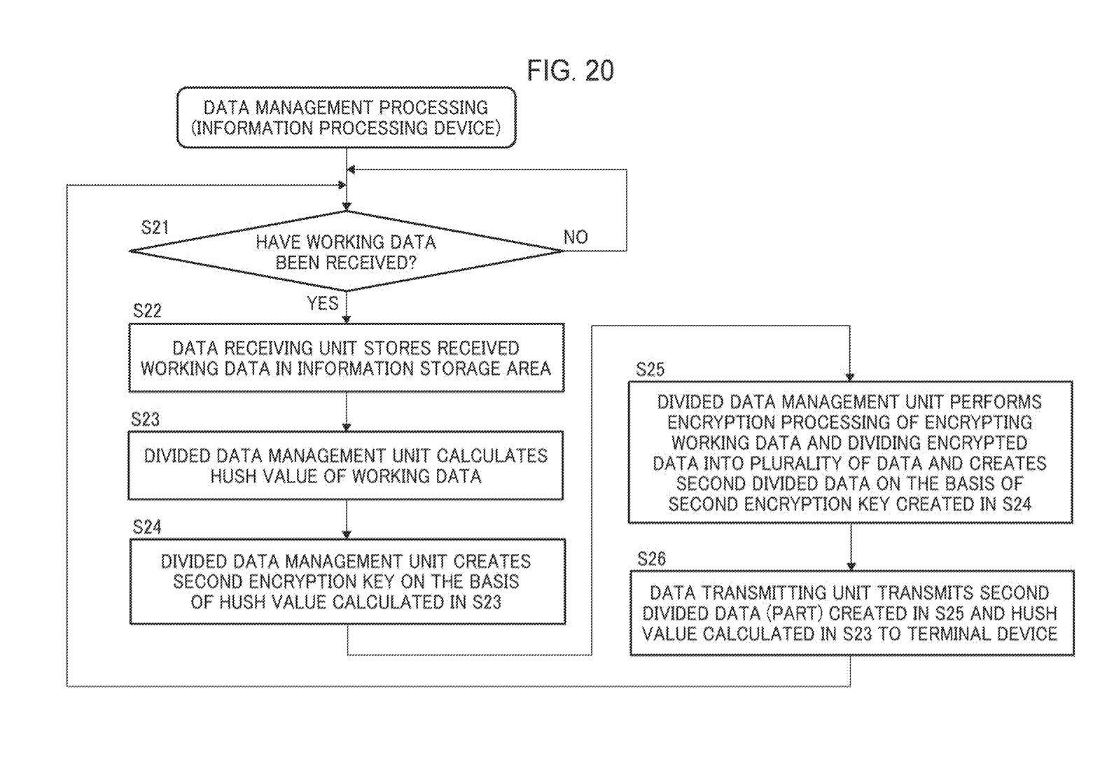

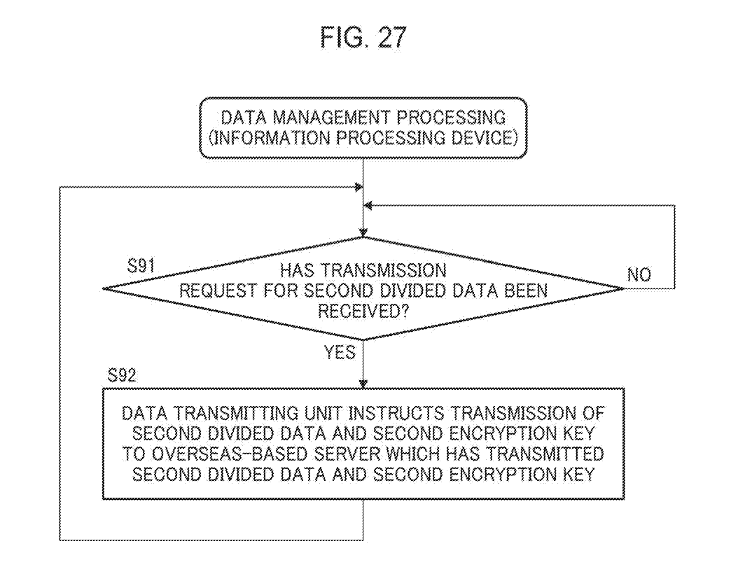

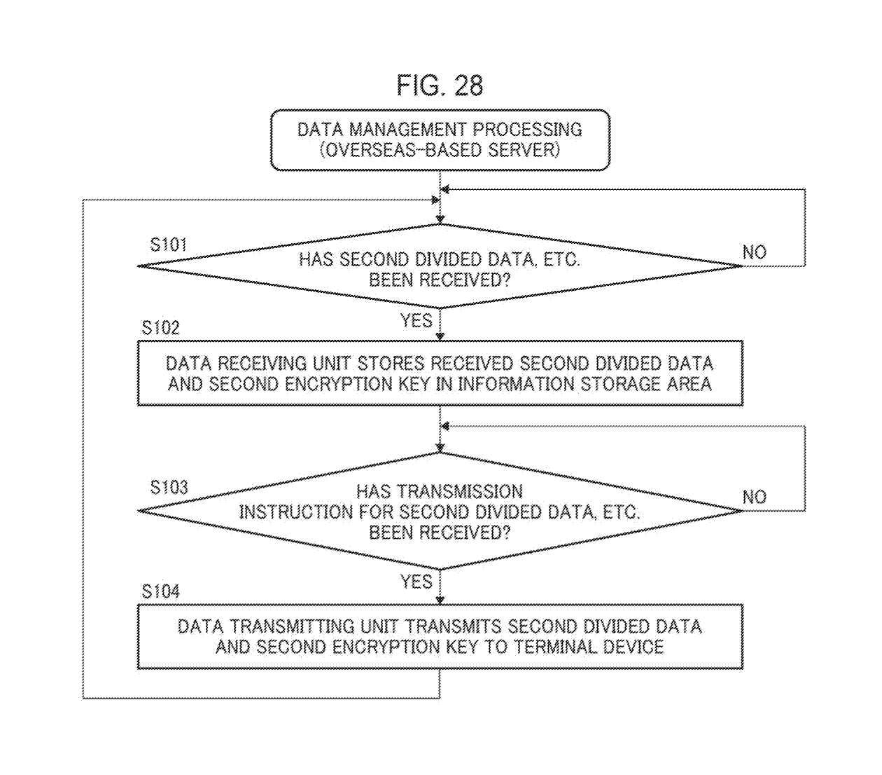

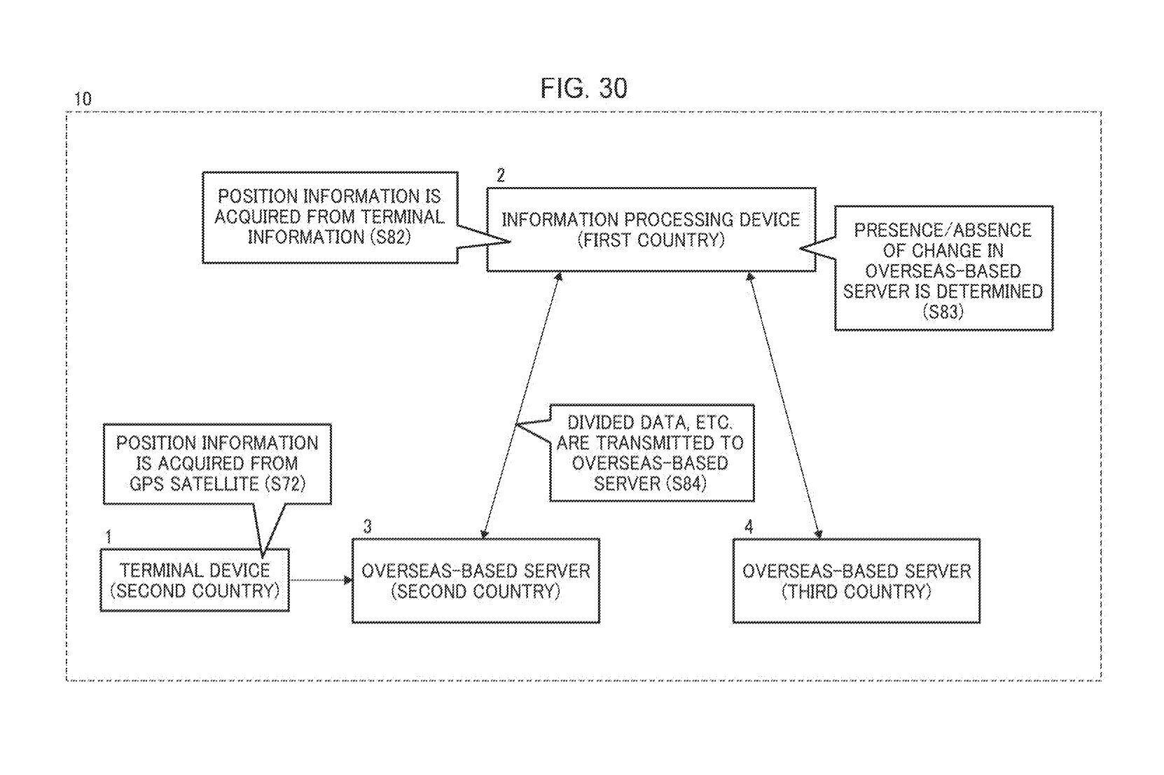

The first embodiment will be explained hereinbelow in greater detail. FIGS. 20 to 29 are flowcharts illustrating in detail the data management processing in the first embodiment. FIG. 30 illustrates in detail the data management processing in the first embodiment. FIGS. 15 to 19 and 30 illustrate the data management processing depicted in FIGS. 20 to 29.

[Processing Performed when the Terminal Device is Disposed in the First Country]

Initially described is the processing performed when the terminal device is disposed in the first country.

As depicted in FIG. 20, the data receiving unit 211 of the information processing device 2 waits till the working data 231 are received from the domestic terminal device 5 (NO in S21). Thus, the data receiving unit 211 waits till the working data 231 corresponding to the materials which are planned to be browsed by the business person during the business trip are stored in the information processing device 2 through the domestic terminal device 5.

Where the working data 231 have been received from the domestic terminal device 5 (YES in S21), the data receiving unit 211 stores the received working data 231 in the information storage area 230 (S22).

The divided data management unit 214 of the information processing device 2 then calculates the hush value 232 of the working data 231 received by the data receiving unit 211 (S23). The divided data management unit 214 then stores the created hush value 232 in the information storage area 230.

The hush value 232 is a value of an irregular fixed length which is determined by a certain calculation procedure from the working data 231. The specific feature of the hush value 232 is that the same hush value is necessarily calculated from the same original data. Therefore, the information processing device 2 and the terminal device 1 can create the same updated data and divided data by calculating the same respective hush values from the same original data and creating the respective encryption keys from the calculated hush value.

Then, the divided data management unit 214 creates the encryption key 233 on the basis of the hush value 232 calculated in S23 (S24). The encryption key 233 performs the encryption of data, for example, by using an RSA encryption algorithm. The divided data management unit 214 stores the created encryption key 233, for example, in the information storage area 230.

The divided data management unit 214 performs the encryption processing of encrypting the working data 231 and dividing the encrypted data into a plurality of data on the basis of the encryption key 233 created in S24 and creates the divided data 236 (S25; S4, S5 in FIG. 15). The specific example of the processing (encryption processing) of S25 will be explained hereinbelow.

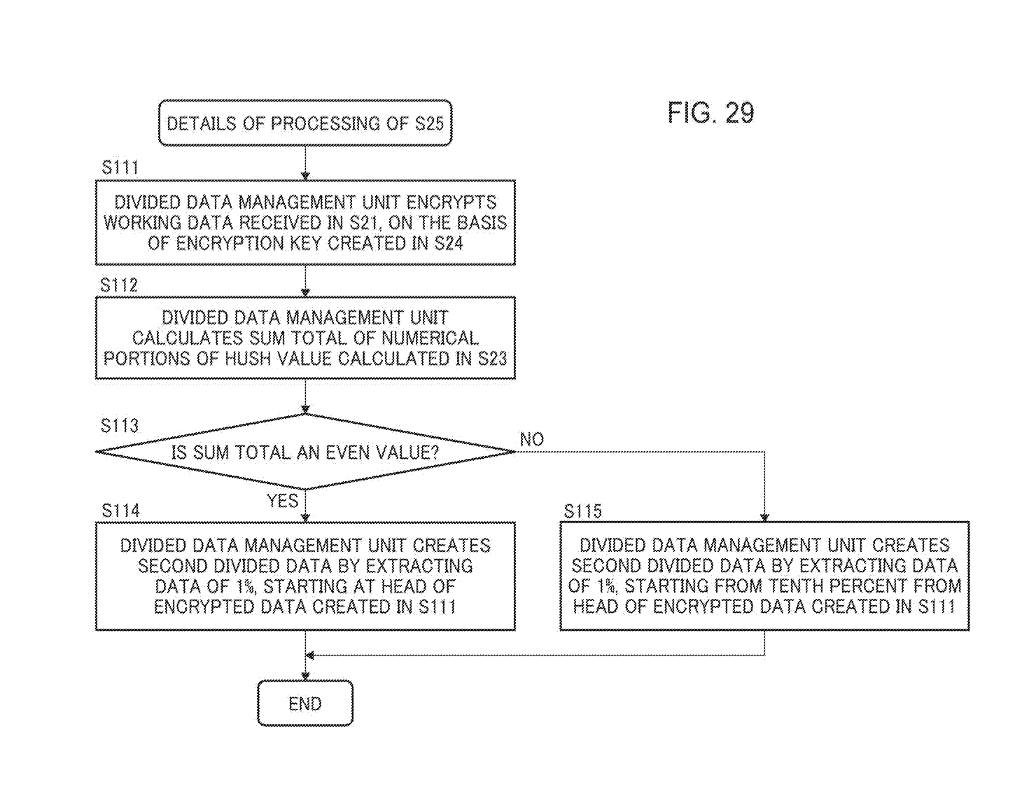

FIG. 29 is a flowchart illustrating the specific example of encryption processing.

As depicted in FIG. 29, the divided data management unit 214 creates the encrypted data 235 by encrypting the working data 231 received in S21 with the encryption key 233 (S111).

Then, the divided data management unit 214, for example, calculates the sum total value of numerical portions of the hush value 232 calculated in S23 (S112). More specifically, when the hush value 232 calculated in S23 is “9b90064097ee3290b73dde4c72f1d4291c01ffdd”, the divided data management unit 214 extracts the numerical portions. Thus, in this case, the divided data management unit 214 extracts “9”, “9”, “0”, “0”, “6”, “4”, “0”, “9”, The divided data management unit 214 then calculates “99” as the sum total thereof.

The divided data management unit 214 then determines whether or not the sum total of the numerical portions extracted in S112 is an even value (S113). Where the sum total of the numerical portions is an even value (YES in S113), the divided data management unit 214 extracts, for example, data of 1%, starting from the head of the encrypted data 235 created in S111. Thus, in this case, the divided data management unit 214 creates the divided data 236 constituted by data of 1%, starting from the head, and data other than the data of 1%, starting from the head, among the data included in the encrypted data 235.

Meanwhile, where the sum total value of the numerical portions is an odd value (NO in S103), the divided data management unit 214 extracts, for example, data of 1%, starting from the tenth percent from the head of the encrypted data 235 created in S111. Thus, the divided data management unit 214 creates the divided data 236 constituted by data of 1%, starting from the tenth percent from the head, and the divided data 236 constituted by other data among the data included in the encrypted data 235.

As a result, the divided data management unit 214 can create the divided data 236 on the basis of the hush value 232.

Returning to FIG. 20, the data transmitting unit 217 of the information processing device 2 transmits part of the plurality of divided data 236 created in S25 and the hush value 232 calculated in S23 to the terminal device 1 (S26, S7 in FIG. 15).

The data transmitting unit 217, for example, transmits to the terminal device 1 the divided data 236 with a larger data amount among the divided data 236 created in S25. More specifically, in the example depicted in FIG. 29, the divided data management unit 214 creates the divided data 236 having a data amount of 1% with respect to the data amount of the working data 231 and the divided data 236 having data amount of 99% with respect to the data amount of the working data 231. Therefore, in this case, the data transmitting unit 217 transmits to the terminal device 1 the divided data 236 having the data amount of 99% with respect to the data amount of the working data 231. As a result, as will be described hereinbelow, the terminal device 1 can restrict the data amount of the divided data 236 which are received at the business trip destination of the business person.

The processing executed by the terminal device 1, when the terminal device is disposed in the first country, will be described hereinbelow.

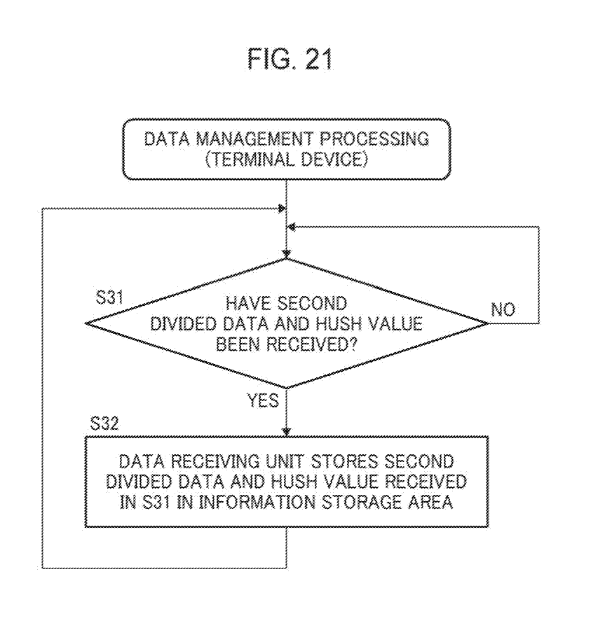

As depicted in FIG. 21, the data receiving unit 111 of the terminal device 1 waits till the divided data 236 and the hush value 232 transmitted by the information processing device 2 are received (NO in S31). Once the divided data 236 and the hush value 232 have been received (YES in S31), the data receiving unit 111 stores the divided data 236 and the hush value 232, which have been received in S31, as the divided data 136 and the hush value 132, respectively, in the information storage area 130 (S32, S12 in FIG. 15).

[Processing Performed when the Terminal Device is Disposed in the Second Country]

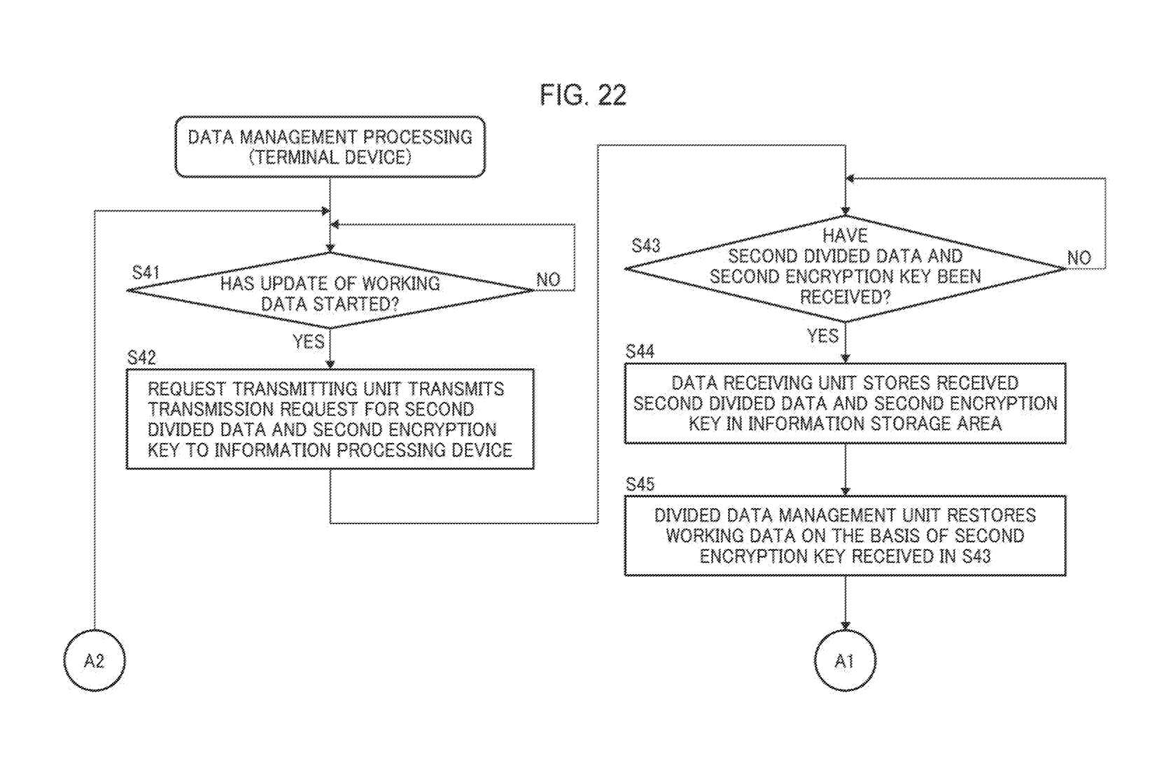

The processing performed when the terminal device is disposed in the second country will be described hereinbelow. As depicted in FIG. 22, the request transmitting unit 115 of the terminal device 1, for example, waits till the business person who has moved to the second country performs an input to the effect that the update of the working data 131 is to be performed (NO in S41). Once the input to the effect that the update of the working data 131 is to be performed has been received (YES in S41), the request transmitting unit 115 transmits a transmission request for the divided data 236 (divided data 236 which have not been stored in the information storage area 130) and the encryption key 233 to the information processing device 2 (S42, S14 in FIG. 16). Then, the data receiving unit 111 waits till the divided data 236 and the encryption key 233 are received (NO in S43).

Thus, when the business person moves from the first country to the second country, all of the divided data 136 necessary for displaying the materials corresponding to the working data 131 are not stored in the information storage area 130 of the terminal device 1 to prevent the occurrence of information leakage. Likewise, in order to prevent the occurrence of information leakage, the encryption key 133 for restoring the divided data 136 is also not stored in the information storage area 130 of the terminal device 1. Therefore, when the business person updates the materials in the second country, the terminal device 1 needs to acquire the divided data 236 (remaining divided data 236) and the encryption key 233 necessary to display the materials which are to be updated.

Further, once the divided data 236 and the encryption key 233 have been received (YES in S43, S15 in FIG. 16), the data receiving unit 111 stores the divided data 236 and the encryption key 233 as the divided data 136 and the encryption key 133, respectively, in the information storage area 130 (S44).

Then, the divided data management unit 114 of the terminal device 1 uses the hush value 132, which has been received in S31, to combine the divided data 136 stored in the information storage area 130 in S31 and the divided data 236 received in S43 (divided data 136 stored in S44). The divided data management unit 114 then creates the encrypted data 135 (S45, S16 in FIG. 16).

Thus, the hush value 132 is identical in contents to the hush value 232 used when the information processing device 2 creates the divided data 236. Further, the plurality of the divided data 136 created by the terminal device 1 is constituted by the contents respectively identical to that of the divided data 236 created by the information processing device 2. Therefore, by using the hush value 132, the divided data management unit 114 can create the encrypted data 135 from the divided data 136 which have been stored in the information storage area 130 in S31 and the divided data 236 received in S43.

Then, the divided data management unit 114 restores the working data 131 from the created encrypted data 135 by using the encryption key 133 which has been stored in the information storage area 130 in S44 (S45, S16 in FIG. 16). As a result, the business person can update the materials at the business trip destination.

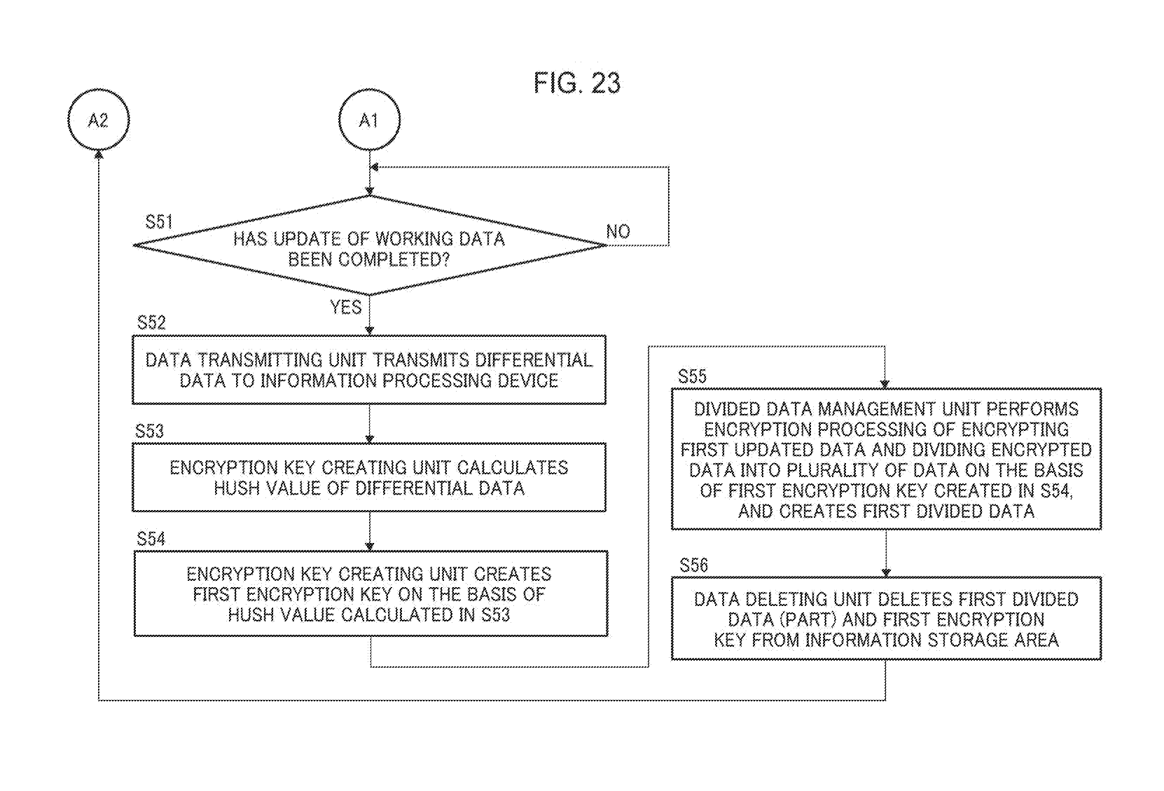

The data transmitting unit 117 of the terminal device 1 then waits, as depicted in FIG. 23, till the update (creation of the updated data 131) of the working data 131 by the business person is completed (NO in S51). Once the updated data 131 have been created, the data updating unit 112 of the terminal device 1 stores the updated data 131 in the information storage area 130.

Once the update of the working data 131 by the business person has been completed (YES in S51, S17 in FIG. 16), the data transmitting unit 117 extracts the differential data between the working data 131 and the updated data 131, and transmits the extracted differential data to the information processing device 2 (S52, S18 in FIG. 17). As a result, as will be described hereinbelow, the information processing device 2 can create the divided data 236 identical in contents to the divided data 136 created by the terminal device 1.

When transmitting the differential data to the information processing device 2, the data transmitting unit 117, for example, may perform the transmission of the differential data encrypted with the encryption key 133 stored in the information storage area 130. As a result, the terminal device 1 can transmit the differential data to the information processing device 2 while ensuring security. Further, the information processing device 2 can restore the received differential data with the encryption key 233 identical in contents to the encryption key 133.

Then, the encryption key creating unit 113 calculates a new hush value 132 from the differential data between the working data 131 before the update and the updated data 131 (S53). The encryption key creating unit 113 then creates a new encryption key 133 on the basis of the hush value 132 calculated in S53 (S54). Thus, the encryption key creating unit 113 creates the new encryption key 133 according to the update (creation of the updated data 131) of the working data 131. The encryption key creating unit 113, for example, stores the hush value 132 calculated in S53 and the encryption key 133 created in S54 in the information storage area 130.

The encryption key creating unit 113, for example, may create a new encryption key 133 on the basis of the hush value 132 calculated in S53 and an encryption key 133 of the previous generation which has been stored in the information storage area 130 (the encryption key 133 which has been stored in the information storage area 130 in S44). More specifically, the encryption key creating unit 113 may create a new encryption key 133, for example, by determining exclusive OR of the values constituting the encryption key 133 of the previous generation and the hush value 132.

Then, the divided data management unit 114 performs the encryption processing with respect to the updated data 131 with the encryption key 133 created in S54. The divided data management unit 114 then creates new encrypted data 135 and new divided data 136 (S55, S19 in FIG. 17). The divided data management unit 114 may also create the new encrypted data 135 and the new divided data 136 by using the updated data 131 created in S51 as an input and performing the processing identical to the processing of S25 explained with reference to FIG. 29.

Then, the data deleting unit 118 of the terminal device 1 deletes part of the plurality of divided data 136 created in S55 and the encryption key 133 created in S54 from the information storage area 130 (S56, S20 in FIG. 17). Further, in the case in which the updated data 131 and the encrypted data 135 have been stored in the information storage area 130, the data deleting unit 118 also deletes those data. As a result, the business person can prevent the occurrence of information leakage even when the terminal device 1 is lost after the updated data 131 have been created at the business trip destination.

The processing executed by the information processing device 2, when the terminal device is disposed in the second country, will be described hereinbelow.

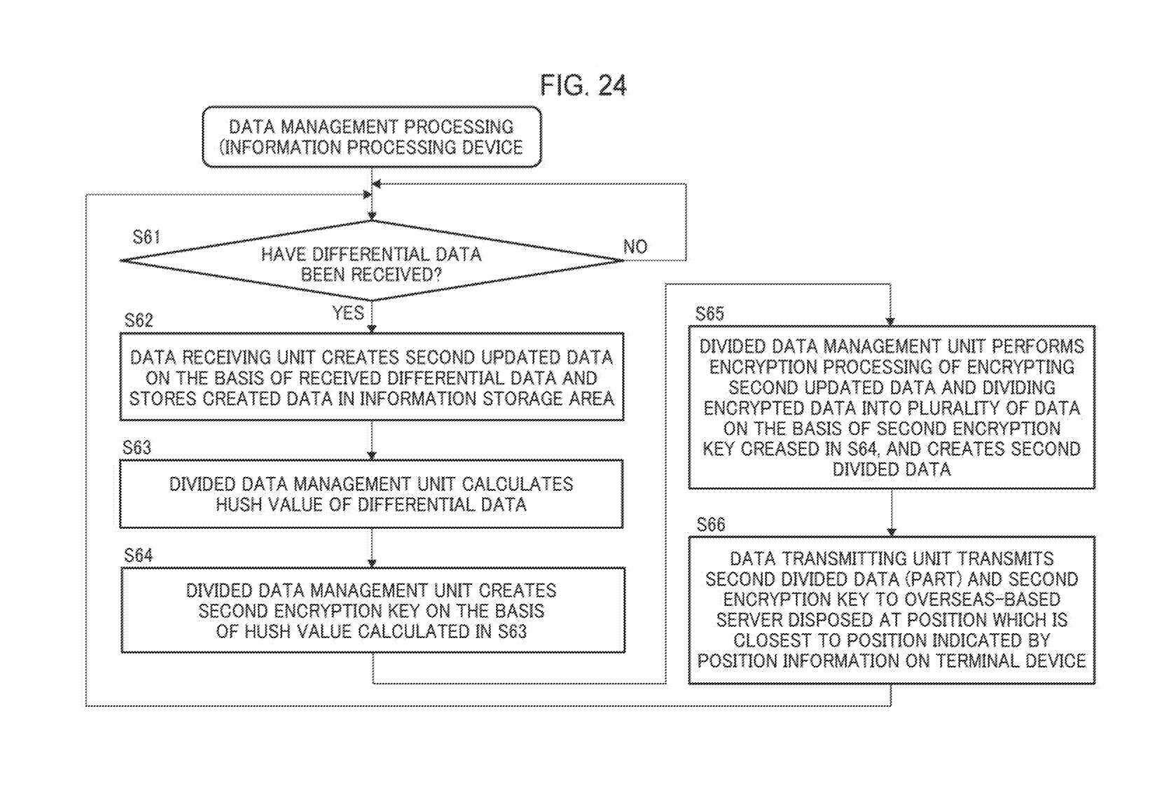

The data receiving unit 211 of the information processing device 2, as depicted in FIG. 24, waits till the differential data are received from the terminal device 1 (NO in S61). Once the differential data have been received from the terminal device 1 (YES in S61, S1 in FIG. 18), the data receiving unit 211 creates the updated data 231 on the basis of the received differential data and stores the created updated data in the information storage area 230 (S62, S3 in FIG. 18). Thus, in S62, the information processing device 2 creates the updated data 231 identical in contents to the updated data 131 created in the terminal device 1.

Then, the divided data management unit 214 calculates a new hush value 232 from the differential data received by the data receiving unit 211 in S61 (S63). The divided data management unit 214 then creates a new encryption key 233 on the basis of the hush value 232 calculated in S63 (S64). The hush value 232 and the new encryption key 233 created by the divided data management unit 214 are identical in contents to the hush value 132 and the encryption key 133, respectively, which have been created by the terminal device 1.

The divided data management unit 214 then performs the encryption processing with respect to the updated data 231 on the basis of the encryption key 233 created in S64 and creates the encrypted data 235 and the divided data 236 (S65, S4 in FIG. 18). The divided data management unit 214 may create the encrypted data 235 and the divided data 236, for example, by using the updated data 231 created in S62 as an input and performing the processing identical to the processing of S25 explained with reference to FIG. 29.

The data transmitting unit 217 then transmits parts of the plurality of divided data 236 created in S65 and the encryption key 233 created in S64 to the overseas-based server disposed at the position which is the closest to the position indicated by the position information 234 among the overseas-based servers (S66, S7 in FIG. 19). Thus, the data transmitting unit 217 transmits to the terminal device 1 the divided data 236 identical in contents to the divided data 136 deleted by the terminal device 1 in S56.

As a result, the divided data 236 identical in contents to the deleted divided data 136 can be acquired even when the divided data 136 have been deleted by the terminal device 1. Therefore, the terminal device 1 can restore the updated data 131 created by the business person even when the divided data 136 have been deleted.

[Processing Performed when the Terminal Device Acquires Position Information]

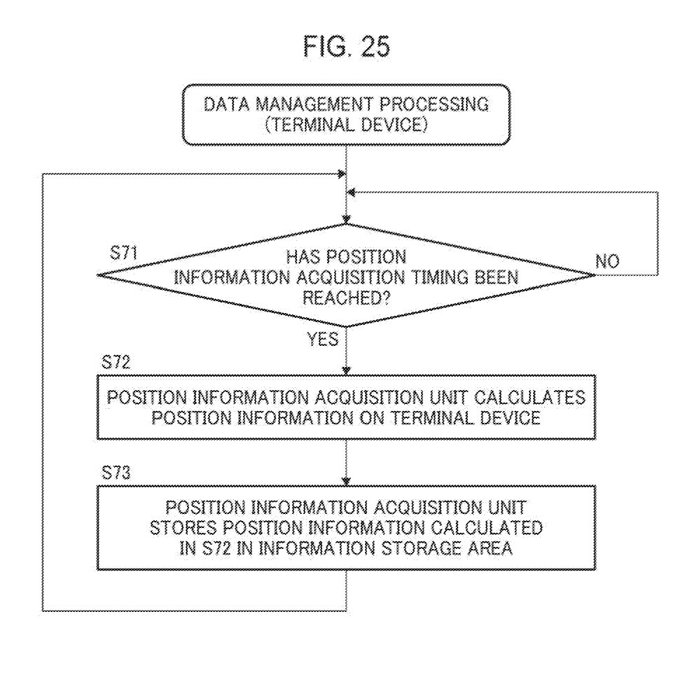

The processing performed when the terminal device 1 acquires position information 134 on the device itself will be explained hereinbelow. The position information acquisition unit 116 of the terminal device 1, as depicted in FIG. 25, waits till a position information acquisition timing is reached (NO in S71). The position information acquisition timing is, for example, a regular timing (1-min interval).

Once the position information acquisition timing has been reached (YES in S71), the position information acquisition unit 116 acquires, as depicted in FIG. 30, the electromagnetic waves transmitted by the GPS satellite and calculates the position information 134 (S72). Then, for example, the position information acquisition unit 116 stores the calculated position information 134 in the information storage area 130 (S73).

[Processing Performed when Divided Data are Transmitted to Overseas-Based Server]

The processing performed when the information processing device 2 transmits the divided data to the overseas-based server will be explained hereinbelow.

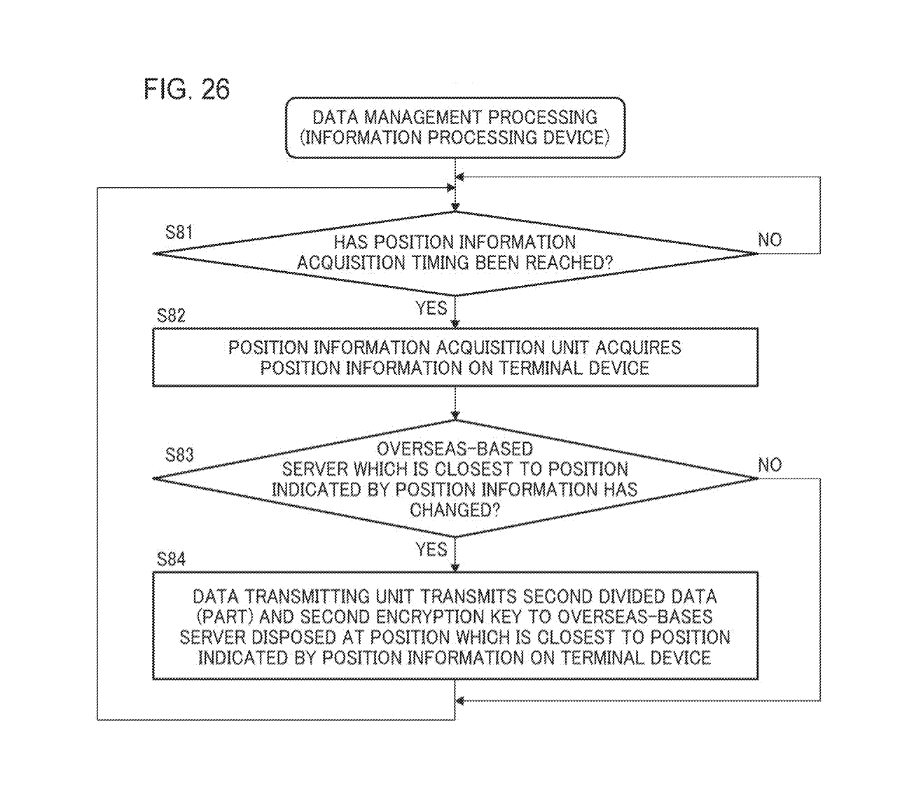

The position information acquisition unit 216 of the information processing device 2, as depicted in FIG. 26, waits till the position information acquisition timing is reached (NO in S81). The position information acquisition timing in FIG. 26 is, for example, a regular timing (1-h interval, or the like).

Once the position information acquisition timing has been reached (YES in S81), the position information acquisition unit 216 acquires, as depicted in FIG. 30, the position information 134 by accessing the terminal device 1 (S82). More specifically, the position information acquisition unit 216 may acquire the position information 134 by transmitting a transmission request for the position information 134 to the terminal device 1. Then, the position information acquisition unit 216 stores the position information 134 on the terminal device 1 as the position information 234 in the information storage area 230.

Then, the data transmitting unit 217 determines, as depicted in FIG. 30, whether or not the overseas-based server which is the closest, among the overseas-based servers, to the position indicated by the position information 234 has changed (S83). Thus, when the business person has moved together with the terminal device 1, the overseas-based server which is the closest to the position of the terminal device 1 can change. Therefore, the data transmitting unit 217, for example, acquires the position information 134 from the terminal device 1 at the regular timings and detects the change in the overseas-based server which is the closest to the position of the terminal device 1.

Where the overseas-based server which is the closest to the position indicated by the position information 234 has changed (YES in S83), the data transmitting unit 217 transmits, as depicted in FIG. 30, part of the divided data 236 and the encryption key 233 to the overseas-based server which is the change destination (S84). Thus, the information processing device 2 transmits the divided data 236 and the encryption key 233 to the overseas-based server not only when new divided data 236 and encryption key 233 have been created, but also when the overseas-based server which is the closest to the position of the terminal device 1 has changed.

As a result, when the business person starts updating the working data 131 at the business trip destination, the terminal device 1 can rapidly acquire the divided data 236 and the encryption key 233 which need to be acquired for updating the working data 131.

When it is detected that the country in which the travelling business person (terminal device 1) stays has changed, the data transmitting unit 217 may transmit the divided data 236 and the encryption key 233 to the overseas-based server disposed in this country (YES in S83, S84). Thus, the data transmitting unit 217 may determine the overseas-based server, to which the divided data 236, etc., need to be transmitted, by the country in which the business person stays, rather than by the distance from the position indicated by the position information 234 to the overseas-based server.

Further, even when it is determined that the overseas-based server which is the closest to the position indicated by the position information 234 has changed, the data transmitting unit 217 may wait till the next position information acquisition timing is reached, without immediately transmitting the divided data 236, etc. (YES in S83, S84). In this case, the data transmitting unit 217 compares the overseas-based server which has been determined as the change destination with the overseas-based server which is the closest to the position indicated by the position information 234 acquired at the next position information acquisition timing. The data transmitting unit 217 may also transmit the divided data 236, etc., to the overseas-based server which is the change destination only when the overseas-based server which has been determined as the change destination is the same as the overseas-based server which is the closest to the position indicated by the position information 234 acquired at the next position information acquisition timing (S84).

Thus, for example, the position information acquisition unit 216 sometimes acquires the position information 234 corresponding to the location in which the business person merely stays during the business trip. Therefore, the overseas-based server which is determined to have changed on the basis of the position information 234 does not necessarily always match the overseas-based server which is the closest to the position indicated by the position information 234 acquired at the next position information acquisition timing. Accordingly, even when the overseas-based server which is the closest to the position indicated by the position information 234 is determined to have changed, the data transmitting unit 217 is allowed not to immediately transmit the divided data 236. As a result, the data transmitting unit 217 can suppress the unnecessary transmission of the divided data 236, etc., to the overseas-based server.

[Processing Performed when the Divided Data are Received from an Overseas-Based Server]

The processing performed when the terminal device 1 receives the divided data from an overseas-based server will be explained hereinbelow.

The request receiving unit 215 of the information processing device 2 waits till the transmission request for the divided data 236 and the encryption key 233 is received from the terminal device 1 (NO in S91). Once the transmission request for the divided data 236, etc., has been received from the terminal device 1 (YES in S91), the data transmitting unit 217 instructs the transmission of the divided data 236, etc., which have been transmitted in S84, to the overseas-based server to which the divided data 236, etc., have been transmitted in S84 (S92). As a result, the information processing device 2 can efficiently transmit the divided data 236 and the encryption key 233 to the terminal device 1 even when the network infrastructure at the business trip destination of the business person is poor.

[Processing in the Overseas-Based Server]

The processing in the overseas-based server 3 will be explained hereinbelow. The processing in the overseas-based server 4 is the same as that in the overseas-based server 3 and the explanation thereof is therefore omitted.

The data receiving unit 311 of the overseas-based server 3 waits till the divided data 236 and the encryption key 233 are received from the information processing device 2 (NO in S101). Once the divided data 236, etc., have been received (YES in S101), the data receiving unit 311 stores the divided data 236 and the encryption key 233 received from the information processing device 2, for example, as the divided data 336 and the encryption key 333, respectively, in the information storage area 330 (S102).

Then, the transmission instruction receiving unit 312 of the overseas-based server 3 waits till the transmission instruction for the divided data 336, etc., is received from the information processing device 2 (NO in S103). Once the transmission instruction for the divided data 336, etc., has been received (YES in S103), the data transmitting unit 313 transmits the divided data 336, etc., to the terminal device 1 (S104). As a result, the information processing device 2 and the terminal device 1 can efficiently perform the transmission of the divided data 236 and the encryption key 233.

Thus, according to the first embodiment, the terminal device 1 receives the working data 231 stored in the first storage unit 230 provided in the information processing device 2 and stores the received data in the second storage unit 130 provided in the terminal device 1. Then, the terminal device 1 transmits to the information processing device 2 the differential data between the working data 131 which have been stored in the second storage unit 130 and the updated data 131 obtained by updating the working data 131.

The terminal device 1 also creates the encrypted data 135 by encrypting the updated data 131 and creates the divided data 136 by dividing the created encrypted data 135 into a plurality of data. The terminal device 1 then deletes part of the created plurality of divided data 136 from the second storage unit 130.

Meanwhile, the information processing device 2 creates the encrypted data 235 by encrypting the updated data 231 which have been updated on the basis of the differential data transmitted from the terminal device 1, and creates the divided data 236 by dividing the created encrypted data 235 into a plurality of data. The information processing device 2 then transmits to the terminal device 1 the divided data 236 identical in contents to the divided data 136, which have been deleted by the terminal device 1, in response to the transmission request from the terminal device 1.

As a result, the information processing device 2 and the terminal device 1 can reduce the data communication amount for preventing the occurrence of information leakage.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data management method comprising:
receiving, by a terminal device, data stored in a first storage provided in an information processing device and storing, by the terminal device, the received data in a second storage provided in the terminal device;
transmitting, by the terminal device, to the information processing device, differential data between the data stored in the second storage and first updated data obtained by updating the data stored in the second storage;
creating, by the terminal device, first encrypted data by encrypting the first updated data;
deleting, by the terminal device, part of the created first encrypted data from the second storage;
creating, by the information processing device, second encrypted data by encrypting second updated data obtained by updating the differential data transmitted from the terminal device; and
transmitting, by the information processing device, to the terminal device, part of the second encrypted data which is identical in contents to the part of the first encrypted data deleted by the terminal device, among the created second encrypted data, in response to a request from the terminal device.

2. The data management method according to claim 1, wherein
the creating the first encrypted data includes creating a plurality of first divided data by dividing the created first encrypted data into a plurality of data, and
the deleting part of the first encrypted data includes deleting part of the first encrypted data from the second storage by deleting at least some first divided data from the plurality of created first divided data.

3. The data management method according to claim 1, further comprising:
before the transmitting part of the second encrypted data, transmitting, by the information processing device, the part of the second encrypted data identical in contents to the part of the first encrypted data deleted by the terminal device to a storage device determined on the basis of position information on the terminal device, wherein
the transmitting part of the second encrypted data includes transmitting the part of the second encrypted data stored in the storage device to the terminal device.

4. The data management method according to claim 3, wherein
the transmitting part of the second encrypted data to the storage device includes transmitting the part of the second encrypted data identical in contents to the part of the first encrypted data deleted by the terminal device to a storage device, among storage devices, which is disposed at a position which is the closest to the position indicated by the position information.

5. The data management method according to claim 1, wherein
the deleting part of the first encrypted data includes determining part of the first encrypted data which is to be deleted on the basis of information included in a hush value generated from the differential data.

6. The data management method according to claim 1, wherein
the creating the first encrypted data includes:
creating a first encryption key from the differential data, and
creating the first encrypted data by encrypting the first updated data with the created first encryption key.

7. The data management method according to claim 6, wherein
the deleting part of the first encrypted data includes deleting the first encryption key,
the creating the second encrypted data includes creating a second encryption key from the differential data transmitted from the terminal device, and
the transmitting part of the second encrypted data includes transmitting the created second encryption key to the terminal device.

8. The data management method according to claim 1, further comprising:
after the transmitting part of the second encrypted data, restoring, by the terminal device, the first updated data from data which have not been deleted among the created first encrypted data and the part of the second encrypted data received from the information processing device.

9. An information processing system comprising:
a terminal device; and
an information processing device, wherein
the terminal device includes:
a receiving processor that receives data stored in a first storage provided in the information processing device,
a second storage that stores the received data,
a transmitting processor that transmits, to the information processing device, differential data between the data stored in the second storage and first updated data obtained by updating the data stored in the second storage,
an encrypted data creating processor that creates first encrypted data by encrypting the first updated data, and
a data deleting processor that deletes part of the created first encrypted data from the second storage, and
the information processing device includes:
an encrypted data creating processor that creates second encrypted data by encrypting second updated data obtained by updating the differential data transmitted from the terminal device, and
a transmitting processor that transmits, to the terminal device, part of the second encrypted data which is identical in contents to the part of the first encrypted data deleted by the terminal device, among the created second encrypted data, in response to a request from the terminal device.

10. A terminal device comprising:
a receiving processor that receives data stored in a first storage provided in an information processing device;
a second storage that stores the received data;
a transmitting processor that transmits, to the information processing device, differential data between the data stored in the second storage and first updated data obtained by updating the data stored in the second storage;
an encrypted data creating processor that creates first encrypted data by encrypting the first updated data; and
a data deleting processor that deletes part of the created first encrypted data from the second storage.

11. The terminal device according to claim 10, further comprising:
a data restoration processor that restores the first updated data from data which have not been deleted among the created first encrypted data and part of second encrypted data received from the information processing device.
